(19) United States
(12) Patent Application Publication
(10) Pub. No.: US 2007/0159845 A1
(43) Pub. Date: Jul. 12, 2007

(54) Surface light source device and apparatus using the same

(75) Inventors: Kazuhide Hirota, Yasu-shi (JP); Masayuki Shinohara, Nagaokakyo-shi (JP); Tetsuya Minobe, Ritto-shi (JP); Jun Kishimoto, Nara-shi (JP)

Correspondence Address: OSHA LIANG L.L.P., 1221 MCKINNEY STREET, SUITE 2800, HOUSTON, TX, 77010, US

(73) Assignee: OMRON Corporation, Kyoto (JP)

(21) Appl. No.: 11/330,833

(22) Filed: Jan. 12, 2006

(51) Int. Cl. F21V 7/04

(52) U.S. Cl. 362/600

(57) ABSTRACT

A surface light source device for preventing the coloring phenomenon in the proximity of a spot light source of a light guide plate making up the surface light source device is disclosed. A spot light source of LED or the like is arranged at an edge of the light guide plate. A multiplicity of deflection patterns having a triangular cross section are arranged on the surface of the light guide plate opposite to the light exiting surface. The light entering the light guide plate are reflected on the deflection patterns and exit from the light exiting surface. The deflection patterns including a plurality of types of deflection patterns having different heights are arranged randomly.

### BACKGROUND OF THE INVENTION

1. Field of the Invention

This invention relates to a surface light source device and an apparatus using the surface light source device.

2. Description of the Related Art

An exploded perspective view and a sectional view of a surface light source device having the ordinary structure are shown in FIGS. 1 and 2, respectively. This surface light source device 1 is used as a backlight and configured of a light guide plate 2 for containing the light, a light emitting unit 3 and a reflector 4. The light guide plate 2 is formed of a transparent resin such as polycarbonate resin or methacryl resin having a large refractive index, and the lower surface of the light guide plate 2 is formed with diffusion patterns 5 by embossing or diffusion reflection ink dot printing. The light emitting unit 3 includes a plurality of light-emitting diodes 7 mounted on a circuit board 6, and is arranged in opposed relation to the side surface (light incidence surface 2a) of the light guide plate 2. The reflector 4 is formed of a white resin sheet, and the each side thereof is attached on the lower surface of the light guide plate 2 by a two-side tape 8.

In this surface light source device 1, as shown in FIG. 2, the light emitted from the light-emitting unit 3 and introduced into the light guide plate 2 from the light incidence surface 2a proceeds while being repeatedly reflected totally between the upper surface (light exit surface 2b) and the lower surface of the light guide plate 2. The light entering the diffusion patterns 5 is diffusively reflected. This light, if incident toward the light exit surface 2b at an angle smaller than the critical angle of total reflection, exits out from the light exit surface 2b. The light that has passed a point lacking the diffusion patterns 5 on the lower surface of the light guide plate 2, on the other hand, is reflected on the reflector 4 and returns into the light guide plate 2. Thus, the light amount loss from the lower surface of the light guide plate 2 is prevented.

In this surface light source device 1 having this structure, though simple in structure, the light utilization efficiency is so low that not more than about 20% of the light emitted from the light-emitting diodes 7 cannot exit from the light exit surface 2b of the light guide plate 2.

The surface light source device 1 shown in FIG. 1 has the light-emitting unit 3 having a plurality of the light-emitting diodes 7 mounted thereon. Therefore, the light-emitting unit 3 cannot be easily reduced in size nor the power consumption of the surface light source device 1 can be reduced.

On the other hand, the surface light source device having light-emitting diodes is light in weight and therefore used for highly portable commodities such as a mobile phone and PDA. To improve the portability, the service life of the power supply of these products is strongly required to be lengthened, and the power consumption of the surface light source device used with these products is also strongly required to be reduced. For this reason, the light-emitting diodes have been used in smaller numbers.

A surface light source device 11 of the structure shown in FIG. 3 using a single light-emitting diode has been proposed. The light guide plate 12 used in this surface light source device 11 includes a non-light emitting area 14 around a rectangular light-emitting area 13 used as a light source. At the end of the short side of the substantially rectangular light guide plate 12, one spot light source 15 using a light-emitting diode is arranged outside of the light-emitting area 13 (in the non-light emitting area 14). Also, the reverse surface of the light guide plate 12 is formed with a multiplicity of concentric deflection patterns 16 around the spot light source 15. The deflection patterns 16, as shown in FIG. 4, are each formed as a depression having a right-angled triangular cross section including a deflection slope 17 and a back reentry surface 18. The interval of the deflection patterns 16 is comparatively large on the side near to the spot light source 15, and progressively decreases with the distance from the spot light source 15. As a result, the surface brightness of the light-emitting area 13 is rendered constant.

In this surface light source device 11, the light emitted from the spot light source 15, as shown in FIG. 4, enters the light guide plate 12 from the light incidence surface and while repeating the total reflection on the obverse and reverse surfaces of the light guide plate 12, proceeds in the light guide plate 12. The light reaching the deflection patterns 16 in the light guide plate 12, as shown in FIG. 4, is reflected on the deflection slope 17 of each deflection pattern 16, emitted toward the obverse surface of the light guide plate 12, and only the light entering the obverse surface of the light guide plate 12 at an incidence angle smaller than the critical angle of total reflection exits out of the surface of the light guide plate 12.

In this surface light source device 11, however, as shown in FIG. 5, the fact that the light is separated into its spectral components in the proximity of the spot light source 15 and the obverse surface appears in seven colors of the rainbow is pointed out as a problem. In FIG. 5, the colored portion is designated by reference character S. In an application as a backlight of the liquid crystal display, for example, this coloring phenomenon in the surface light source device 11 is visible even on the screen of the liquid crystal display and deteriorates the image quality. Thus, the problem of coloring phenomenon in the surface light source device 11 is required to be solved.

### SUMMARY OF THE INVENTION

This invention has been achieved to solve the problem of the prior art described above, and the object of the invention is to prevent the coloring phenomenon appearing in the proximity of the light source.

According to a first aspect of the invention, there is provided a surface light source device comprising a light guide plate for containing and emitting the light from a light exit surface by being expanded in planar form, and a light source for causing the light to enter the light guide plate, wherein convex or concave deflection patterns for light deflection are formed on the other surface of the light guide plate opposite to the light exit surface, wherein a plurality of types of deflection pattern different in light diffraction characteristic are arranged in at least a part of the deflection pattern forming area, and wherein the light diffracted through the deflection patterns are mixed with each other thereby to whiten the light exiting from the light guide plate.

With the surface light source device according to the first aspect of the invention, the light diffracted through a plurality of deflection patterns different in diffraction characteristic are mixed with each other and thereby the light exiting from the light guide plate can be whitened. Therefore, the coloring phenomenon in the surface light source device can be suppressed.

According to a second aspect of the invention, there is provided a surface light source device comprising a light guide plate for containing and emitting the light from a light exit surface by being expanded in planar form and a light source for causing the light to enter the light guide plate, wherein convex or concave deflection patterns for light deflection are formed on the other surface of the light guide plate opposite to the light exit surface, wherein a plurality of types of deflection patterns having different shapes of cross section are mixed with each other in at least a part of the deflection pattern forming area.

As a method of differentiating the shape of the cross section of the deflection patterns, the size of the deflection patterns is changed. The height or width, for example, of the cross section of the deflection patterns can be changed, or the size thereof is either increased or decreased. In the case where the deflection pattern has a substantially triangular cross section, the inclination angle of the light incidence surface of each deflection pattern may be changed to obtain a deflection pattern of a different shape of the cross section. The deflection patterns having different shapes of cross section may be arranged randomly or regularly. Also, the shape of the cross section of the deflection patterns may be changed randomly or into a plurality of (preferably, three or more) types.

With the surface light source device according to the second aspect of the invention, a plurality of types of deflection patterns having different shapes of cross section are arranged mixed in at least a part of the deflection pattern forming area. Thus, different deflection patterns have different directions in which the diffracted light exits, and the diffracted light having different wavelengths are mixed with each other thereby to whiten the diffracted light exiting from the light guide plate, thereby suppressing the coloring phenomenon of the surface light source device.

Also, with the surface light source device according to the second aspect of the invention, the average (the average of deflection pattern height, inclination angle, etc.) of the shape of the cross section of the deflection patterns is substantially uniform for the entire deflection pattern forming area, and therefore the brightness of the surface light source device can be equalized over the whole deflection pattern forming area.

With the surface light source device according to the second aspect of the invention, a plurality of the deflection patterns having different shapes of cross section are arranged in the proximity of the light source, the deflection patterns having uniform shape of cross section are arranged in an area far from the light source, and a plurality of types of the deflection patterns having different shapes of cross section are arranged between the proximity of the light source and the area far from the light source in such a manner that the difference of the shape of the cross section of the deflection patterns of different types is progressively decreased from the proximity of the light source toward the area far from the light source. According to this embodiment, the shape of the cross section of the deflection patterns is prevented from being changed abruptly, and therefore the boundary line of the change is prevented from becoming conspicuous.

According to a third aspect of the invention, there is provided a surface light source device comprising a light guide plate for containing and emitting the light from a light exit surface by being expanded in planar form and a light source for causing the light to enter the light guide plate, wherein convex or concave deflection patterns for light deflection are formed on the other surface of the light guide plate opposite to the light exit surface, wherein the deflection patterns having a uniform shape of cross section are formed in the area far from the light source, and wherein the deflection patterns having a uniform shape of cross section larger than the cross section of the deflection patterns in the area far from the light source are arranged in the proximity of the light source.

With the surface light source device according to the third aspect of the invention, the cross section of the deflection patterns formed in the proximity of the light source is larger than that of the deflection patterns in the area far from the light source, and therefore the diffraction angle of the light diffracted by the deflection patterns in the proximity of the light source can be reduced. As a result, the diffracted light having different wavelengths can be mixed directly or using a diffusion sheet or the like, thereby preventing the coloring phenomenon and whitening the diffracted light. The cross section of the deflection patterns in the proximity of the light source is desirably at least twice as large as the cross section of the deflection patterns in the area far from the light source.

According to a fourth aspect of the invention, there is provided a surface light source device comprising a light guide plate for containing and emitting the light from a light exit surface by being expanded in planar form, and a light source for causing the light to enter the light guide plate, wherein convex or concave deflection patterns for light deflection are formed on the other surface of the light guide plate opposite to the light exit surface, and wherein the thickness of the light guide plate is not more than 0.4 mm.

The conventional surface light source device uses a light guide plate about 0.85 mm thick and therefore easily develops the coloring phenomenon in the proximity of the light source. In the surface light source device according to the fourth aspect of the invention, on the other hand, the thickness of the light guide plate is set to not more than 0.4 mm (more preferably, about 0.2 mm), and therefore the difference of incidence angle of the light entering the deflection patterns can be reduced. This increases the superposition of and whitens the diffracted light, thereby suppressing the coloring phenomenon in the surface light source device.

The surface light source device according to the invention can be used as an image display device in combination with a liquid crystal display panel or other image display panel, thereby producing an image display device free of the coloring phenomenon on the screen. Also, this image display device can be used as a display of a portable device such as a mobile phone or a portable information terminal.

The component elements according to the invention described above can be arbitrarily combined with each other as far as practicable.

### BRIEF DESCRIPTION OF THE DRAWINGS

FIG. 1 is an exploded perspective view of a conventional surface light source device.

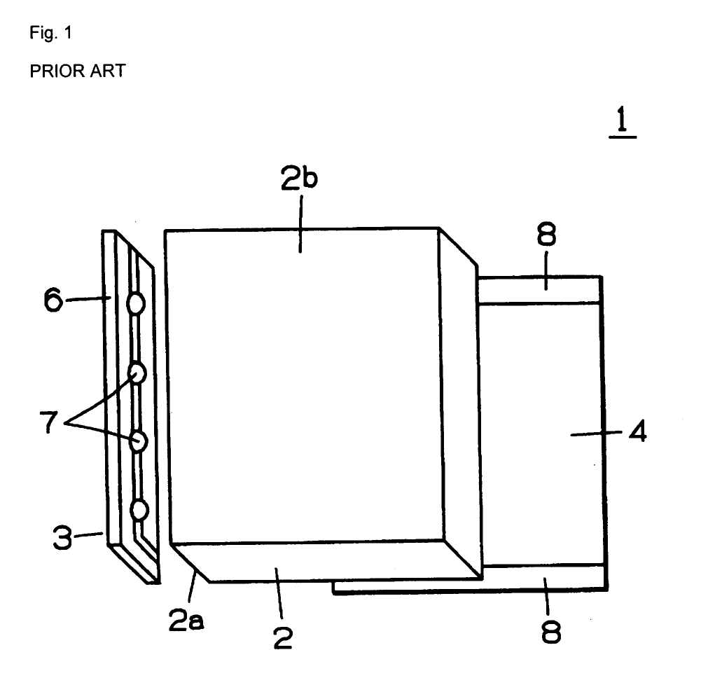

FIG. 2 is a schematic sectional view of the conventional surface light source device.

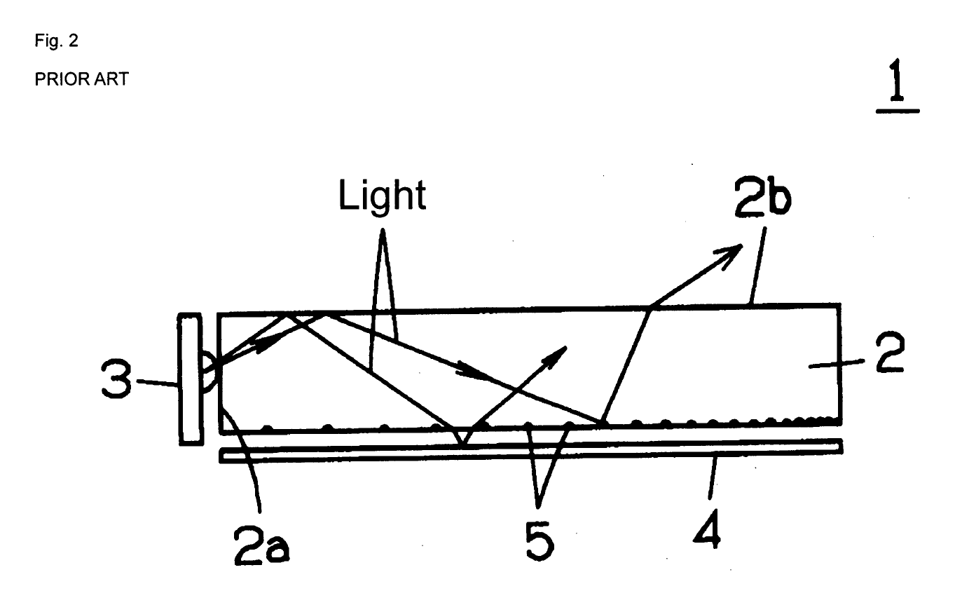

FIG. 3 is a plan view of another conventional surface light source device.

FIG. 4 is a schematic sectional view and a partially enlarged view of the light guide plate of the conventional surface light source device.

FIG. 5 is a drawing showing the coloring phenomenon developed in the proximity of a spot light source of the conventional surface light source device.

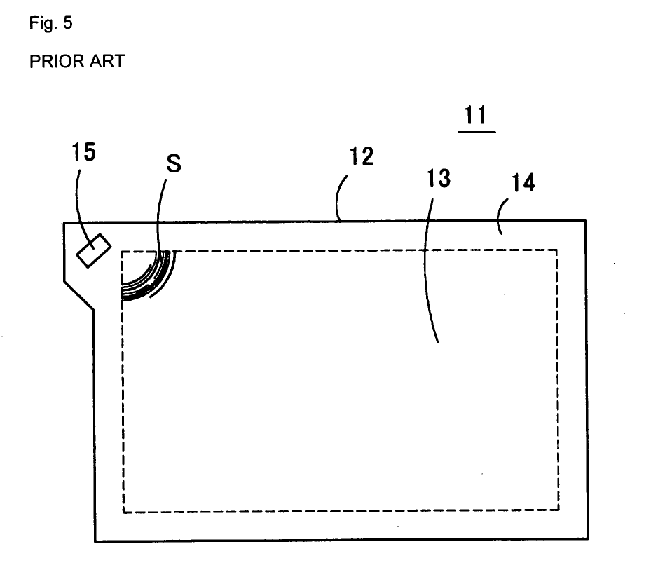

FIG. 6 is an exploded perspective view of a surface light source device according to a first embodiment of the invention.

FIG. 7 is a schematic sectional view of the surface light source device shown in FIG. 6.

FIG. 8 is a view of the reverse surface of the light guide plate used with the surface light source device shown in FIG. 6.

FIG. 9 is an enlarged sectional view of a spot light source used with a surface light source device shown in FIG. 6.

FIG. 10 schematically shows the arrangement of the deflection patterns formed on the light guide plate shown in FIG. 6.

FIG. 11A is a plan view of the deflection pattern shown in FIG. 10, and FIG. 11B is an enlarged sectional view taken in line X-X in FIG. 11A.

FIG. 12A is a diagram for explaining the operation of the deflection slope of a deflection pattern, and FIG. 12B is a diagram for explaining the operation of a reentry surface of the deflection pattern.

FIG. 13A is a plan view of a light guide plate having deflection patterns, FIG. 13B is an enlarged view of portion A in FIG. 13A, FIG. 13C is an enlarged view of portion B in FIG. 13A, and FIG. 13D is an enlarged view of portion C in FIG. 13A.

FIG. 14 shows the relation between the distance from the spot light source and the pattern density of the deflection patterns of the light guide plate shown in FIG. 13A.

FIG. 15 shows the relation between the distance from the spot light source and the pattern length of the deflection patterns of the light guide plate shown in FIG. 13A.

FIG. 16 shows the relation between the distance from the spot light source and the pattern number density (number of patterns divided by area) of the deflection patterns of the light guide plate shown in FIG. 13A.

FIG. 17 schematically shows the structure and the operation for sending a great quantity of light to the corners of the light exit surface of the surface light source device according to an embodiment of the invention.

FIG. 18 schematically shows a light guide plate defined by a fixing frame.

FIG. 19 is a diagram for explaining the process of inducing an equation indicating the diffraction angle.

FIG. 20 shows the diffraction characteristic of the light reflected on the deflection patterns, with the abscissa representing the diffraction angle θ.

FIG. 21 shows the diffraction characteristic of the light reflected by the deflection patterns at different positions.

FIG. 22 shows the regular reflected light from the deflection patterns and the primary diffracted light of red, green and blue.

FIG. 23 shows the regular reflected light on the deflection patterns at different positions and the primary diffracted light of red, green and blue of red, green and blue.

FIGS. 24A, B and C show the diffraction characteristic of the light reflected by the deflection patterns at different positions, in which the abscissa represents the angle φ of the diffraction direction.

FIG. 25A shows a partly cutaway sectional view of the surface light source device as a comparison embodiment having a high light source, and FIG. 25B shows the diffraction characteristic thereof.

FIG. 26A shows the light incident to the deflection pattern in the proximity of a spot light source of the conventional surface light source device, and FIG. 26B shows the diffraction characteristic thereof.

FIG. 27 shows the light incident to the deflection pattern located far from the spot light source of the conventional surface light source device.

FIG. 28 is a partly enlarged sectional view of the reverse surface of the light guide plate used with the surface light source device according to an embodiment of the invention.

FIG. 29 shows a comparison of three types of deflection patterns formed in the light guide plate shown in FIG. 28.

FIG. 30 shows the diffraction angle of the primary diffracted light of red, green and blue in the deflection patterns shown in FIG. 29.

FIGS. 31A, B and C show the regular reflected light on the three types of deflection patterns shown in FIG. 29 and the primary diffracted light of red, green and blue.

FIG. 32 shows a comparison of the deflection patterns formed on the reverse surface of the light guide plate of the surface light source device according to a second embodiment of the invention.

FIG. 33 shows the diffraction angle of the primary diffracted light of red, green and blue in the deflection patterns shown in FIG. 31.

FIGS. 34A, B and C show the regular reflected light on the three types of deflection patterns shown in FIG. 32 and the primary diffracted light of red, green and blue.

FIG. 35 is a schematic partly cutaway sectional view of the surface light source device according to a modification of the first embodiment.

FIG. 36 is a schematic partly cutaway sectional view of the surface light source device according to a third embodiment of the invention.

FIG. 37A is a schematic partly cutaway sectional view of the surface light source device according to a fourth embodiment of the invention, and FIG. 37B is a schematic partly cutaway sectional view of the prior art for comparison.

FIG. 38 shows a schematic diagram of a liquid crystal display device using the surface light source device according to an embodiment of the invention.

FIG. 39 is a perspective view of a mobile phone using the liquid crystal display device according to an embodiment of the invention.

FIG. 40 shows a perspective view of a portable information terminal using the liquid crystal display device according to an embodiment of the invention.

### DESCRIPTION OF THE EMBODIMENTS

### First Embodiment

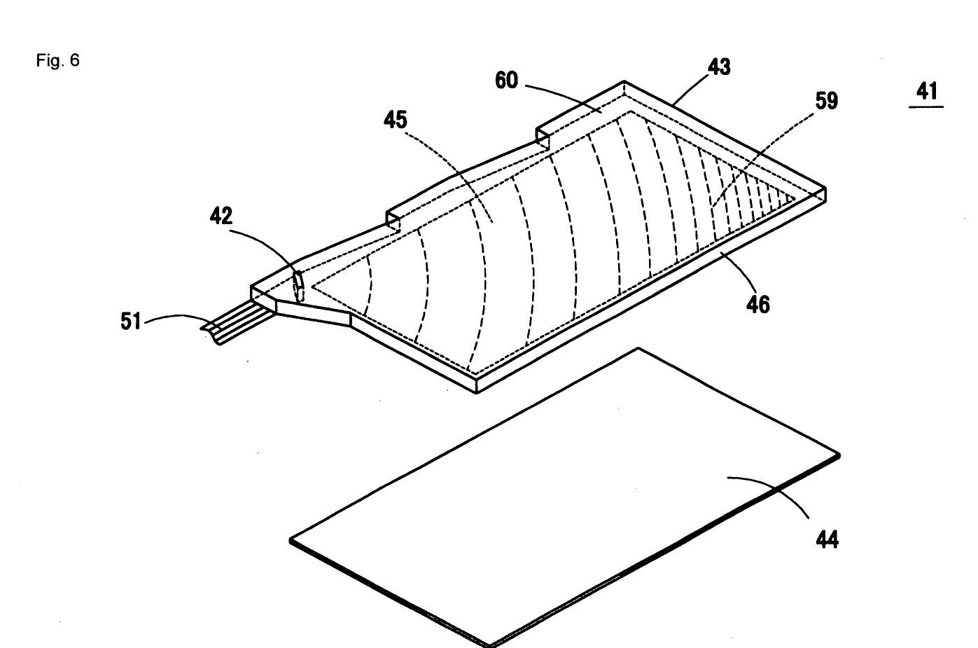

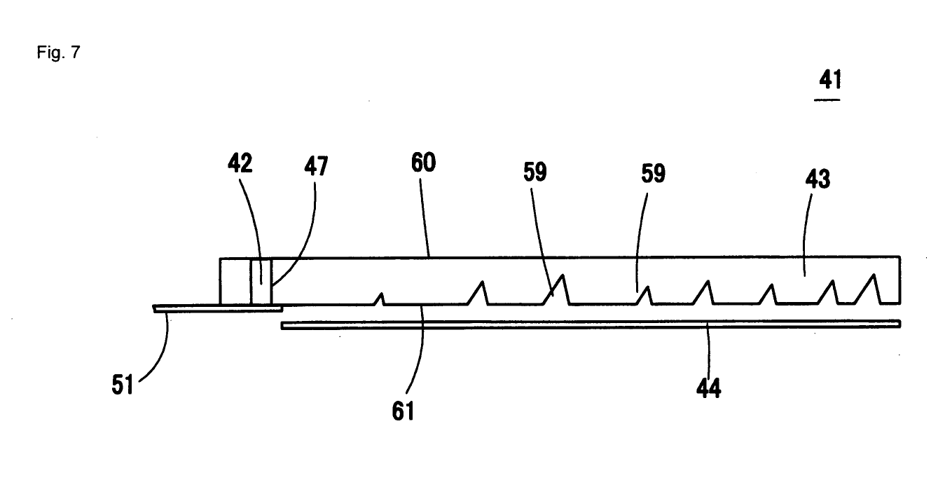

FIG. 6 is an exploded perspective view showing the configuration of the surface light source device 41 according to a first embodiment of the invention. FIG. 7 is a sectional view thereof. The surface light source device 41 is used as a backlight and includes a spot light source 42, a light guide plate 43 and a reflection sheet 44. The spot light source 42 is buried at a corner of the light guide plate 43, and the reflection sheet 44 is arranged in opposed relation to the reverse surface of the light guide plate 43.

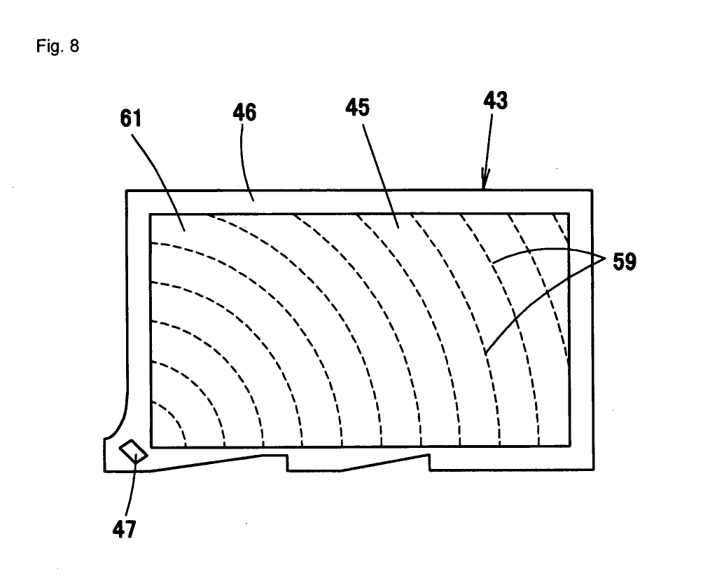

The light guide plate 43 is formed of a transparent resin high in refractive index such as polycarbonate resin, acryl resin, methacryl resin or glass in a substantially rectangular flat shape. FIG. 8 shows the reverse surface of the light guide plate 43. The reverse surface of the light guide plate 43 is formed with a non-light emitting area 46 around a rectangular planar light emitting area 45 providing a substantially surface light source, and a hole 47 to fit the spot light source 42 is open to the outside of the surface light emitting area 45 (non-light emitting area 46) at an end of the short side of the rectangular light guide plate 43. The spot light source 42, which is resin molded of a light-emitting diode chip, is mounted on a film wiring board (FPC) 51 for supplying power to the spot light source 42 and inserted in the hole 47 of the light guide plate 43.

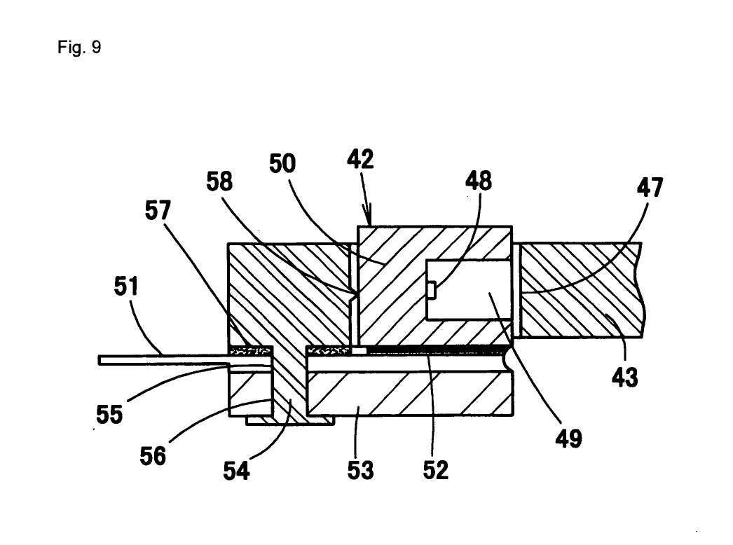

FIG. 9 is a sectional view showing the structure of the spot light source 42. This spot light source 42 is configured of a light-emitting diode chip 48 sealed in the transparent resin 49, and the surfaces of the chip 48 other than the front surface thereof are covered by a white resin 50. This spot light source 42 is mounted on the film wiring board 51 and fixed by a solder 52. Further, the film wiring board 51 is fixed on a reinforcing plate 53 of glass epoxy resin. The hole 47 for accommodating the spot light source 42 is formed vertically through a corner of the light guide plate 43, and a positioning pin 54 is projected from the lower surface of the light guide plate 43 in the proximity of the hole 47. The film wiring board 51 and the reinforcing plate 53, on the other hand, are formed with through holes 55, 56 for inserting the positioning pin 54.

An ultraviolet-cured adhesive (which may alternatively be a thermosetting adhesive) 57 is coated on the lower surface of the light guide plate 43 around the base portion of the positioning pin 54, and the positioning pin 54 is inserted into the through holes 55, 56 of the film wiring board 51 and the reinforcing plate 53. The center along the thickness of the light guide plate 43 and the light emission center of the spot light source 42 are positioned by a CCD camera, etc., after which the ultraviolet light is radiated to set the ultraviolet-cured adhesive 57. Thus, the light guide plate 43 and the spot light source 42 are bonded to each other, and the positioning pin 54 is further thermally caulked to the reinforcing plate 53.

In the process, as shown in FIG. 9, the center of the spot light source 42 may alternatively be positioned by a protrusion 58 from the inner surface (or the back surface, the front surface or both the back and front surfaces of the spot light source 42) of the hole 47 of the light guide plate 43. Though not shown, the center of the light guide plate 43 and the center of the spot light source 42 may be positioned using a stepped jig for positioning the upper surface of the light guide plate 43 and the upper surface of the spot light source 42 while the light guide plate 43 and the spot light source 42 are in vertically inverted positions.

The film wiring board 51 may be replaced with a glass epoxy wiring board or a lead frame. Also, in the case where two or more light-emitting diode chips are used, a plurality of light-emitting diode chips may be concentrated at one point to form a spot light source. Further, the spot light source 42 may be formed by insertion molding of a light-emitting diode chip directly in the light guide plate 43, or may be arranged outside of the light guide plate 43 (at a position in opposed relation to the outer peripheral surface of the light guide plate 43). Incidentally, the spot light source is defined as a light source having an internal light-emitting unit not more than 9 mm in size. Especially, in the case where a plurality of light-emitting units (which may be either sealed integrally or separately) are involved, the distance from the light-emitting unit at one end to the light-emitting unit at the other end is not more than 9 mm.

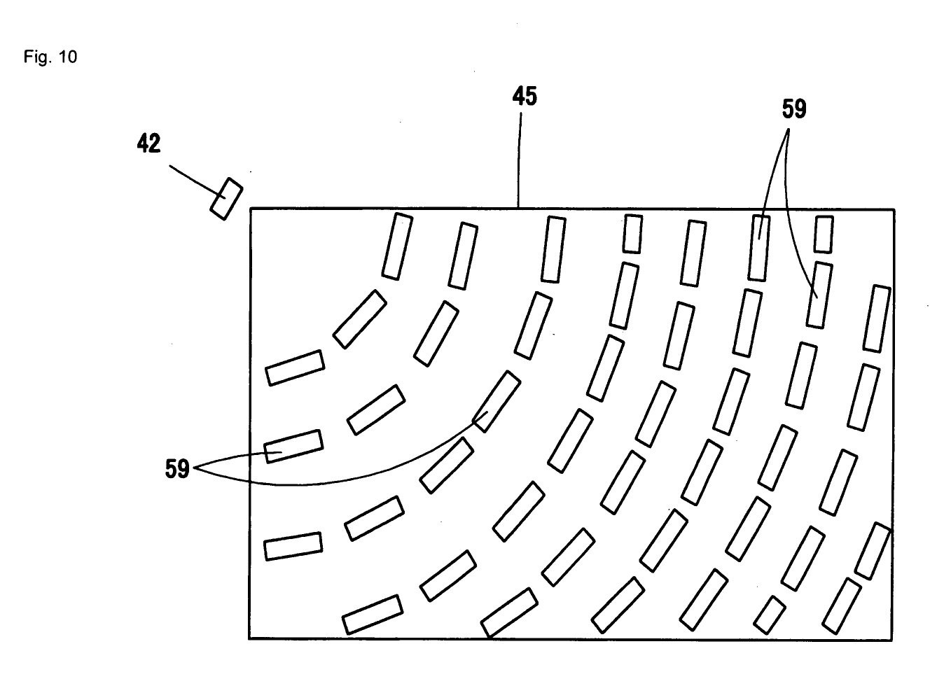

A plurality or multiplicity of triangular prismatic deflection patterns 59 are concentrically formed as depressions around the spot light source 42, as shown in FIG. 10, in the surface light-emitting area 45 on the reverse surface of the light guide plate 43. The interval between the deflection patterns 59 is comparatively large on the side nearer to the spot light source 42 and progressively reduced with the distance away from the spot light source 42. As a result, the uniform brightness is secured on the obverse surface (hereinafter referred to as the light emitting surface 60) and the reverse surface (hereinafter referred to as the pattern surface 61) of the light guide plate 43. Also, the deflection patterns 59 are varied in size (size of the cross section of the pattern) randomly over the whole or a part of the surface light-emitting area 45, and the cross sections are similar in shape to each other. These deflection patterns 59 are described in detail below.

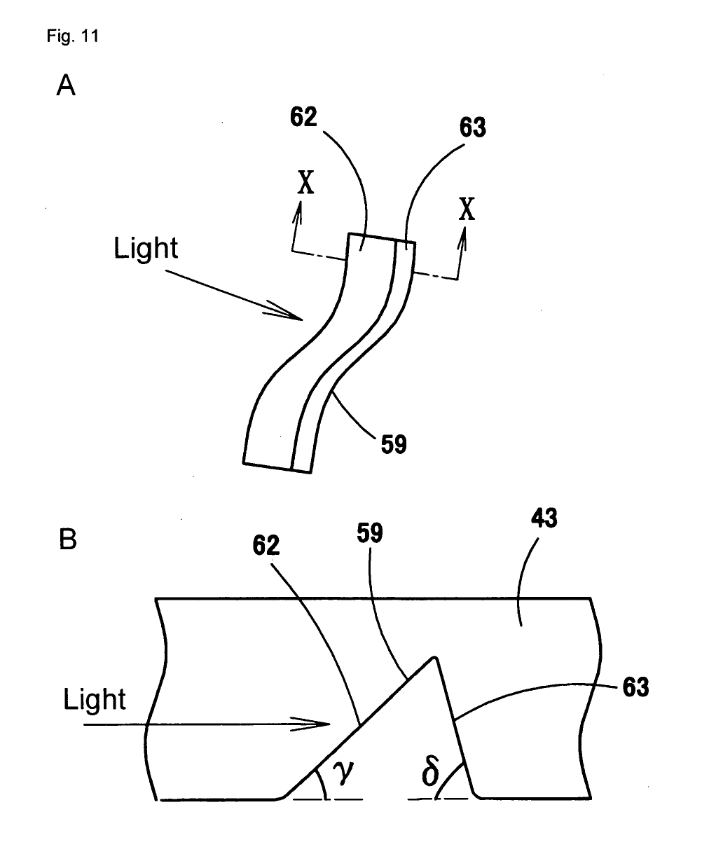

FIGS. 11A and B are a plan view and an enlarged sectional view, respectively, showing the shape of the deflection pattern 59. The deflection pattern 59 has a substantially uniform longitudinal cross section and is arranged in such a position that the length thereof is substantially perpendicular to the line connecting to the spot light source 42. Each deflection pattern 59 used in this embodiment is somewhat waved as shown in FIG. 11A. Each deflection pattern 59, as shown in FIG. 11B, includes a deflection slope 62 located nearer to the spot light source and a reentry surface 63 located farther from the spot light source 42, and has a substantially triangular cross section formed by the deflection slope 62 and the reentry surface 63. The inclination angle γ of the deflection slope 62 and the inclination angle δ of the reentry surface 63 desirably assume the following values:
γ<δ
γ=45° to 65°
δ=80° to 90°
   Especially, the desirable inclination angle δ of the pattern surface 61 is about 80° and the desirable inclination angle γ of the deflection slope 62 is about 55°.

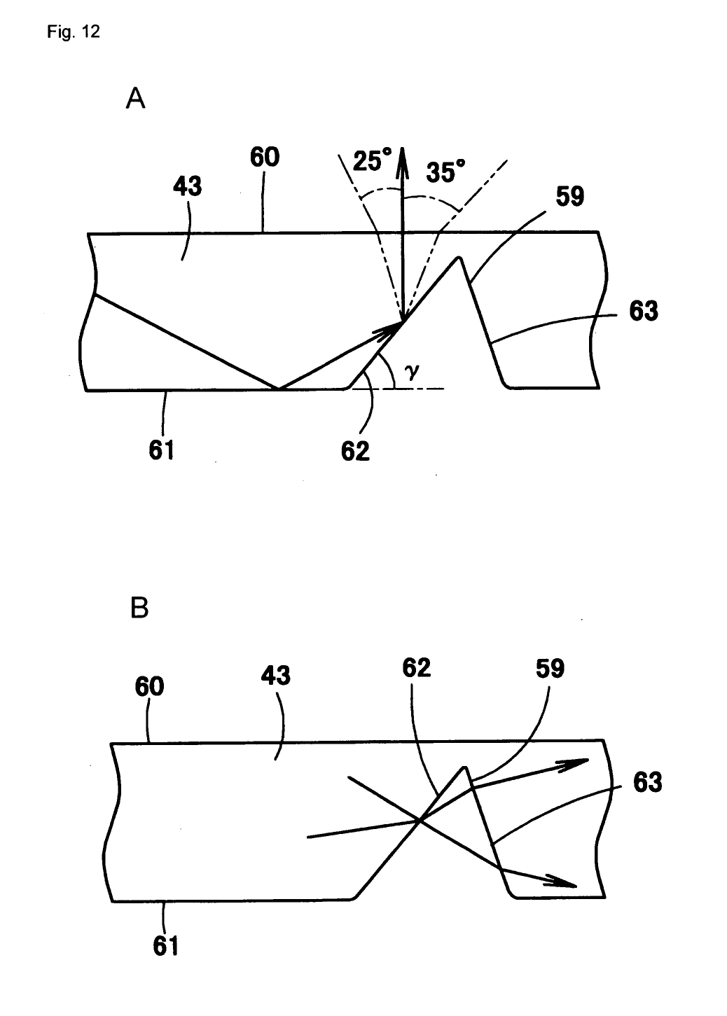

The light emitted from the spot light source 42 and entering the light guide plate 43 through the inner wall surface of the hole 47 repeats the total reflection on the obverse surface (light emitting surface 60) and the reverse surface (pattern surface 61) of the light guide plate 43, and thus propagating through the light guide plate 43, spreads in planar form over the whole surface light-emitting area 45 of the light guide plate 43. The light entering the deflection slope 62 of the deflection pattern 59 from below, as shown in FIG. 12A, is totally reflected by the deflection slope 62 toward the light-emitting surface 60 and exits from the light-emitting surface 60. Assume that the light guide plate 43 of a transparent resin having the refractive index n of 1.53 is used. As shown in FIG. 12A, for the inclination angle γ of 55° of the deflection slope 62, the light is emitted from the light guide plate 43 in an angular range of −20° to +35° with respect to the direction perpendicular to the light-emitting surface 60. This results from the fact that the light radiated on the deflection pattern 59 from below is reflected on the deflection pattern 59, while the light radiated from above enters the light guide plate 43 again from the back surface (reentry surface 63) as shown in FIG. 12B.

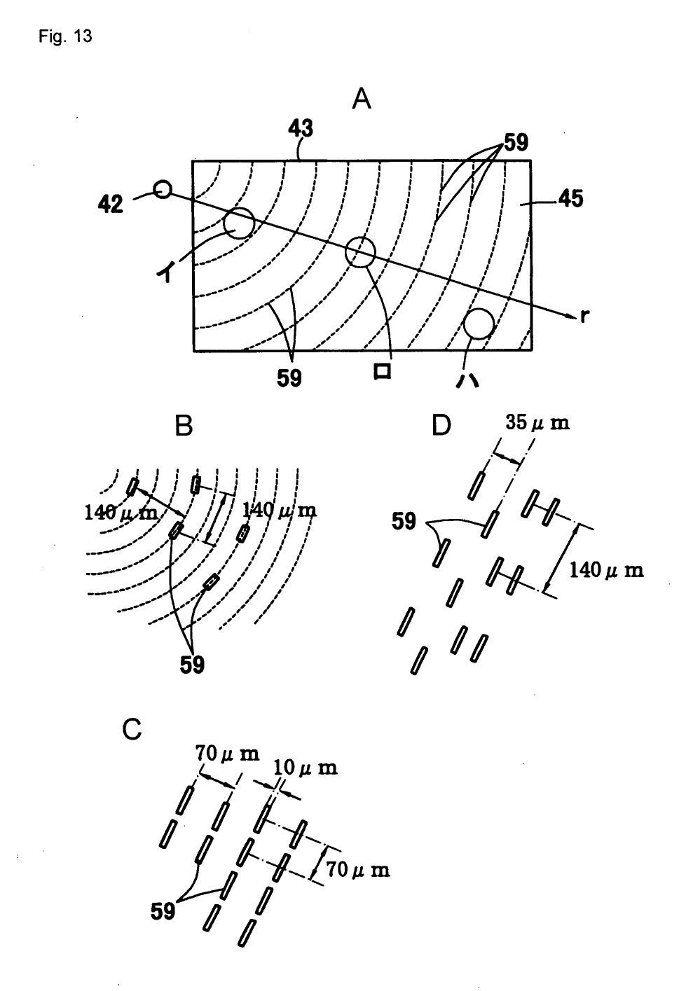

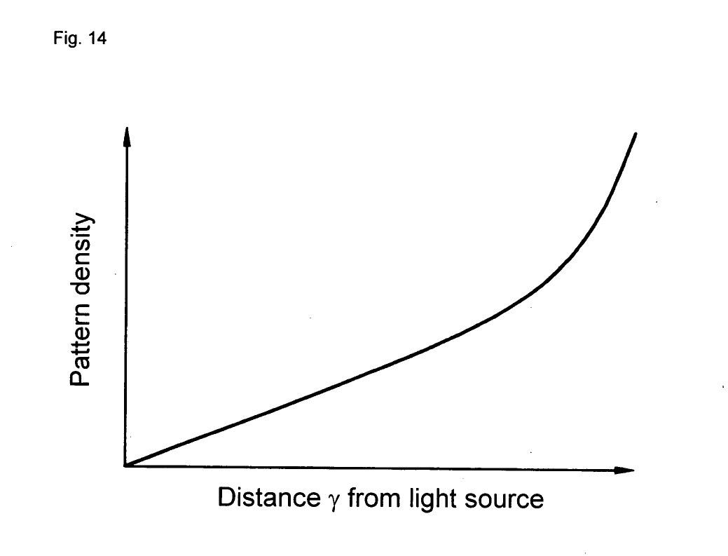

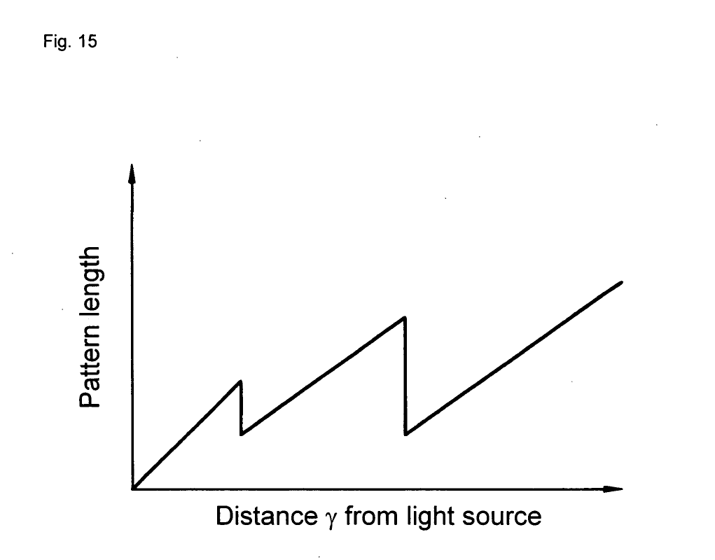

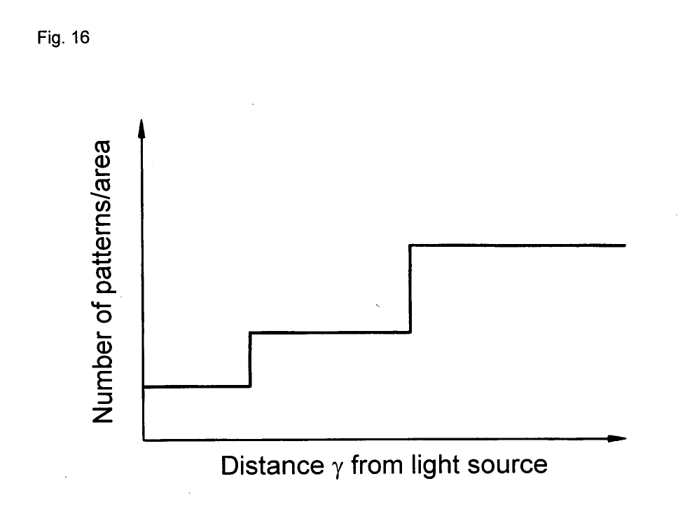

FIGS. 13A, B, C, D show various manners in which the whole deflection patterns 59 are arranged. FIG. 14 shows the change in pattern density (area ratio) of the deflection patterns 59 in radial direction, FIG. 15 the change in pattern length, and FIG. 16 the change in the number of patterns per unit area. Character γ designates the distance from the spot light source 42. The density of the deflection patterns 59 increases with the distance γ from the spot light source 42 as shown in FIG. 14 to secure a uniform brightness of the light-emitting surface 60 and the pattern surface 61. The density of the deflection pattern can be progressively increased by increasing the number of the deflection patterns per unit area. According to this embodiment, however, the light guide plate 43 is divided into a plurality of annular zones in accordance with the distance from the spot light source 42, each zone having a predetermined number of patterns per unit area as shown in FIG. 16, while the number of deflection patterns per unit area is increased stepwise from one zone to another as shown in FIG. 16. Also, the length of the deflection pattern is gradually changed from one zone to another as shown in FIG. 15. The pattern length is provisionally shortened in the zone boundary.

FIGS. 13B, C and D show the deflection patterns 59 specifically at points A, B and C, respectively. FIG. 13B shows the area A nearest to the spot light source 42, where the pitch of the deflection patterns 59 in both radial direction and circumferential direction is 140 μm and the inner deflection patterns 59 and the outer deflection patterns 59 are not laid one on the other in radial direction. FIG. 13C shows the intermediate area B, where the pitch of the deflection patterns 59 in both radial direction and circumferential direction is 70 μm and two rows each of the inner deflection patterns 59 and the outer deflection patterns 59 are laid one on the other in radial direction. FIG. 13D shows the area C far from the spot light source 42, where the pitch of the deflection patterns 59 in radial direction is 35 μm and the pitch thereof in the circumferential direction is 140 μm. Although linearly extending deflection patterns are illustrated in FIGS. 13B, C and D, the wavy patterns 59 as shown in FIG. 11 may be arranged as shown in FIGS. 13B, C and D.

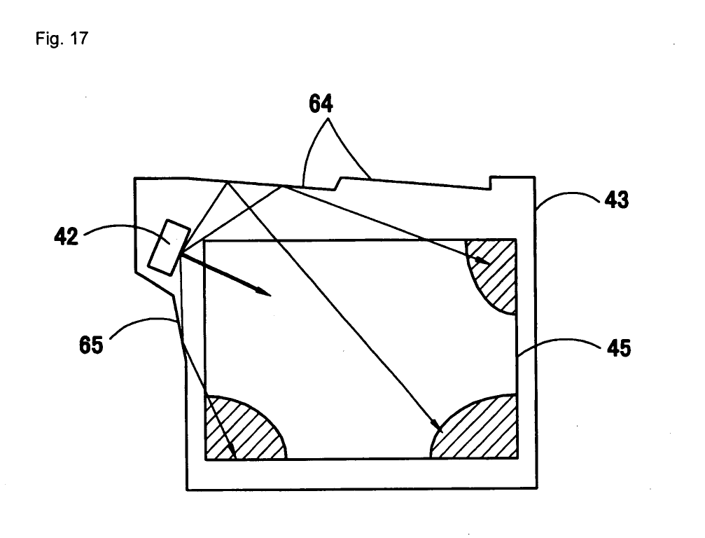

The long side of the light guide plate 43 far from the end thereof at which the spot light source 42 is located is formed linearly, while the long side of the light guide plate 43 near to the spot light source 42 has one or a plurality of steps cut obliquely. In similar fashion, the short side of the light guide plate 43 near the spot light source 42 is partly formed obliquely. In the case where the slopes 64, 65 are formed on the long and short sides, respectively, near to the spot light source 42, as shown in FIG. 17, part of the light emitting from the spot light source 42 is totally reflected from the slope 64 on the long side and the slope 65 on the short side, so that light can be transmitted to the corners (the areas hatched in FIG. 17) of the light guide plate 43. In the case where the spot light source 42 is located at a corner of the light guide plate 43, the other corners tend to be darkened. In the structure described above, however, the light totally reflected from the slopes 64, 65 is transmitted to the corners of the surface light-emitting area 45 of the light guide plate 43, so that a uniform brightness distribution on the light-emitting surface 60 and the pattern surface 61 can be secured, thereby improving the efficiency of the surface light source device 41.

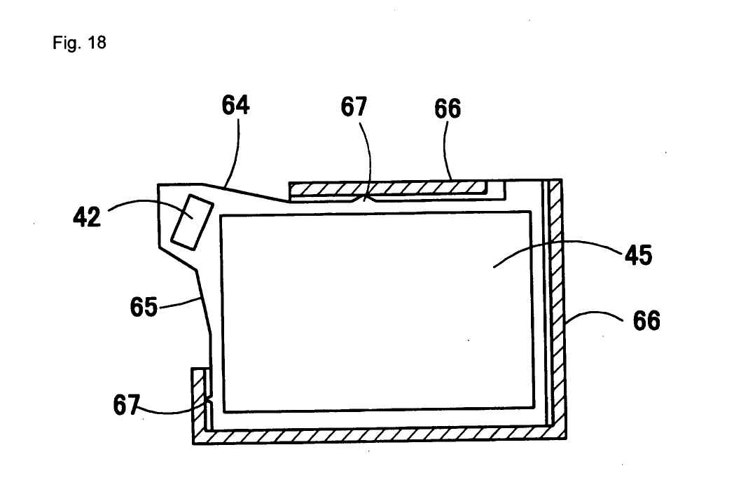

In the case where a fixing frame 66 is mounted on the light guide plate 43 as shown in FIG. 18, a structure in which the light-reflecting slopes 64, 65 and the fixing frame 66 are closely attached to each other may be liable to damage the slopes 64, 65 of the light guide plate 43 and adversely affect the reflection characteristic. To obviate this disadvantage, small convex portions 67 are formed in a part or the proximity of the light-reflecting slopes 64, 65. In this way, the light guide plate 43 is brought into contact with the fixing frame 66 through the convex portions 67, while a gap is formed between the slopes 64, 65 and the fixing frame 66 at the same time.

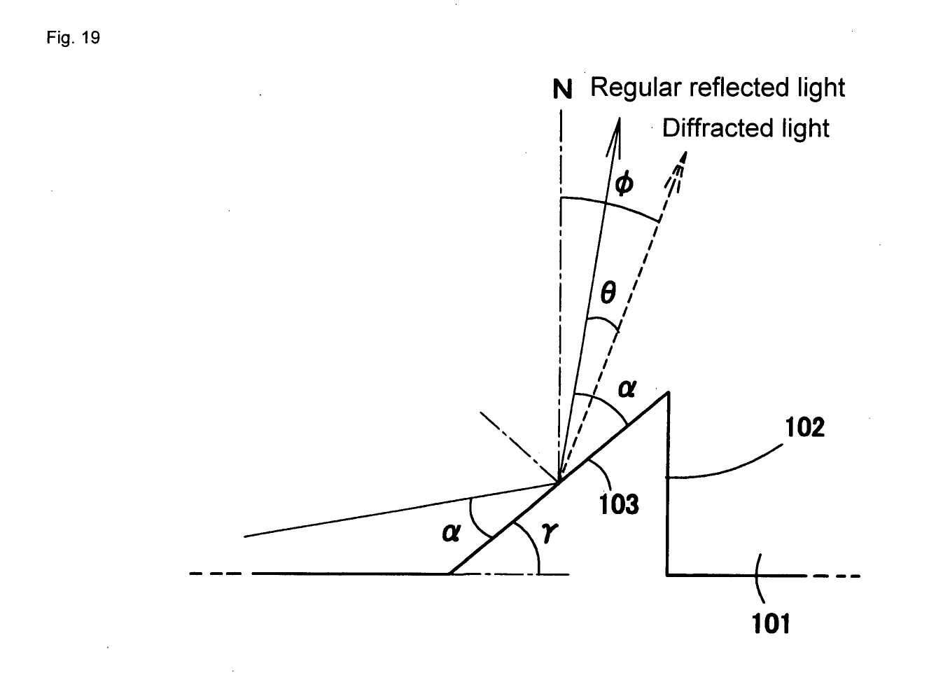

Next, the reason why the coloring phenomenon occurs in the proximity of the spot light source in the prior art and the coloring phenomenon is obviated in the embodiment described above are explained. Consider the Fraunhofer diffraction of the parallel light incident at an incidence angle of 90°−α (α is hereinafter referred to as the incidence elevation angle) to the deflection pattern 102 having the inclination angle γ formed on the light guide plate 101 as shown in FIG. 19. Assume that the light is reflected in the direction at the diffraction angle θ from the direction of regular reflection, as shown in FIG. 19. The light path difference A between the light reflected at the ends of the reflection pattern 102 is given as
Δ=a·cos(α−θ)−a·cos α (1)
where a is the length of the deflection slope 103. Let λ be the wavelength of the light, and the intensity of the diffracted light assumes a local minimum value when the light path difference Δ is an integer multiple of the wavelength λ. Thus, the direction of diffraction in which the diffracted light is darkened is given as
Δ=a·cos(α−θ)−a·cos α=mλ(2)
where m=±1, ±2 and so forth.

Assuming that the diffraction angle θ is sufficiently small, Equation (2) leads to Equation (3) below.
θ=mλ/(a·sin α) [dark] (3)

The diffracted light is assumed to have a local maximum value at the central portion in the direction in which the diffracted light intensity expressed by Equation (3) is minimum. Then, the particular direction is expressed by Equation (4) below.

$$θ = \{ \begin{matrix}( 2 m + 1 ) λ / ( 2 a . \cdot sin α ) & ( m = 1 , 2 , … ) \\ 0 ° & ( m = 0 ) \\ ( 2 m - 1 ) λ / ( 2 a \cdot sin α ) & ( m = - 1 , - 2 , … )\end{matrix} \qquad ( 4 )$$

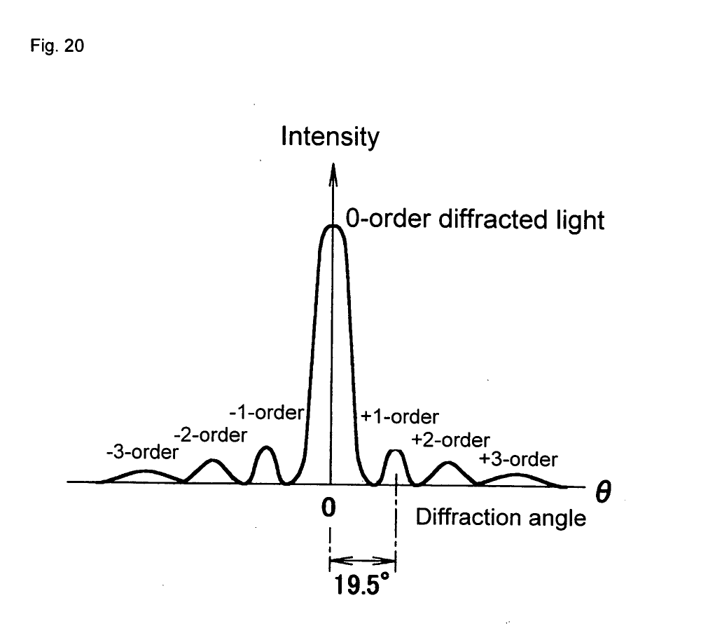

With the entry of the light into the deflection pattern 102, the diffracted light is generated together with the regular reflected light (zero-order light), and the ±1-order light and ±2-order light are generated on both sides of the zero-order light. The ±1-order light and ±2-order light are generated in the direction determined by Equation (4) and the direction θ of diffraction thereof is proportional to the wavelength of the light and inversely proportional to the length a of the deflection slope 103. FIG. 20 is a diagram for explaining the Fraunhofer diffraction, in which the abscissa represents the diffraction angle θ and the ordinate the light intensity. What is important here is the ±1-order light (the +1-order light and the −1-order light are hereinafter referred to collectively as the primary light), and the direction of diffraction of the primary light is given as
θ=3λ/(2a·sin α) (5)
Assume that the length a of the deflection slope 103 is 4.9 μm, the incidence elevation angle α is 30° and the wavelength λ of the light is 550 nm. Then, from Equation (5), the diffraction angle θ of the primary light is given as
θ=0.34 rad=19.5°

Next, the Fraunhofer diffraction of the parallel light from a white light source which enters the deflection slope 103 is explained. In the case where the spot light source 104 constitutes a white light source configured of a white LED or the like, the light emitted from the spot light source 104 contains the light having the wavelength in the visible range of red to violet. As shown in Equation (4), a different wavelength λ of the incident light leads to a different diffraction angle θ for the same length a of the deflection slope 103. Assuming that the wavelength λ of the red (R), green (G) and blue (B) light are 700 nm, 550 nm and 400 nm, respectively, the length a of the deflection slope 103 is 4.9 μm and the incidence elevation angle α is 30°, the diffraction angles θr, θg and θb of the primary diffracted light of the respective colors are given as

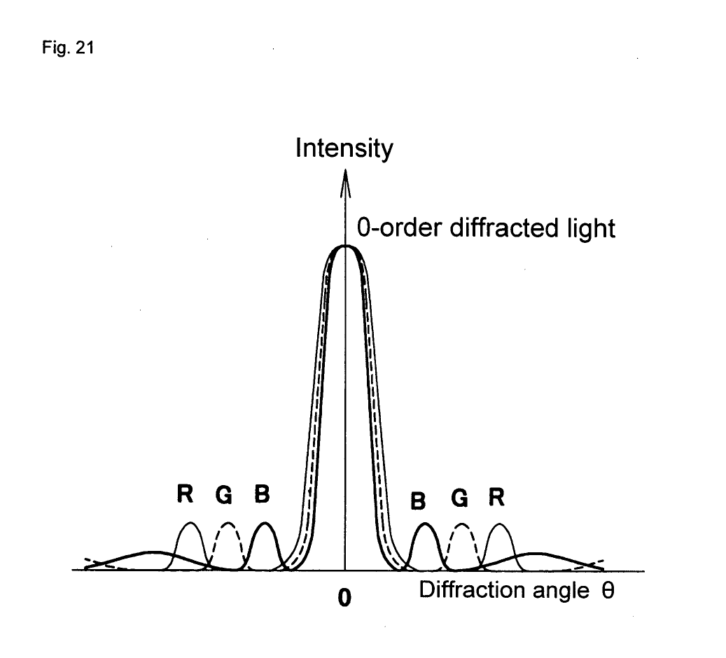

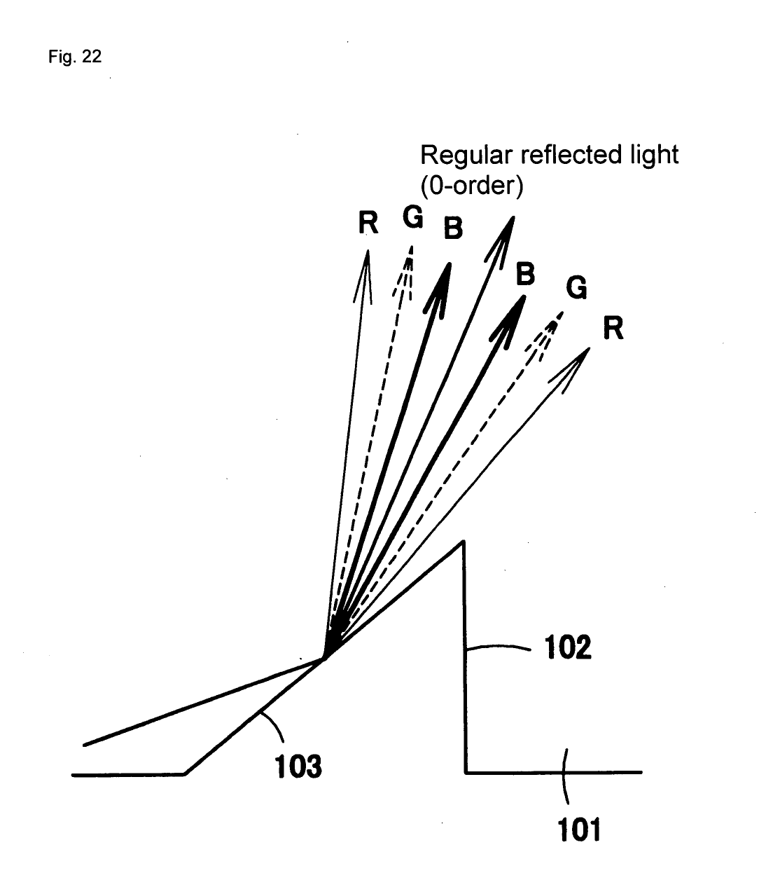

θr=24.8°
θg=19.5°
θb=14.2°
   Thus, the light of the respective wavelengths are subjected to the Fraunhofer diffraction as shown in FIG. 21 (in which R designates the primary diffracted light of red, G the primary diffracted light of green, and B the primary diffracted light of blue). As a result, as shown in FIG. 22, after the white light enters the deflection pattern 102, the primary diffracted light of different wavelengths are diffracted in different directions, respectively, so that the difference of not less than 10° is caused in terms of diffraction angle between the primary diffracted light of red and blue. The light diffused in this way cannot be mixed even by a diffusion plate placed on the light guide plate 101.

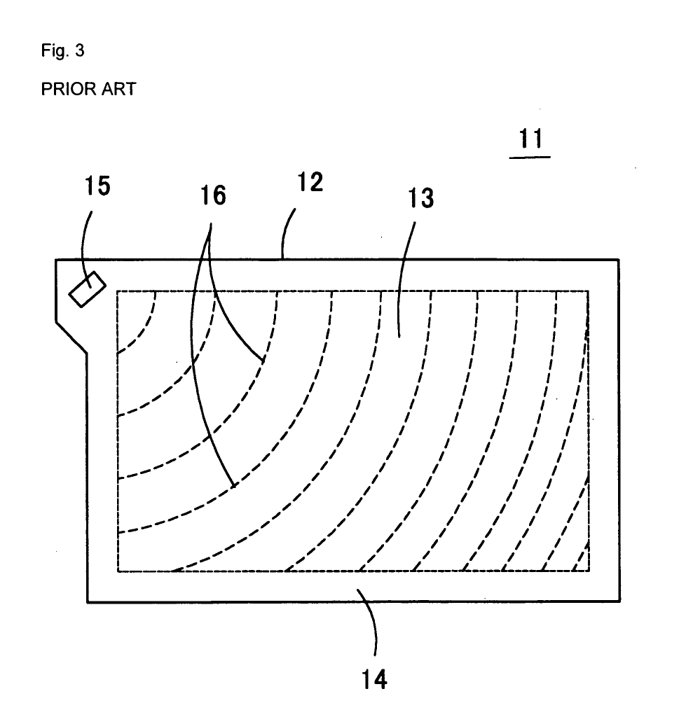

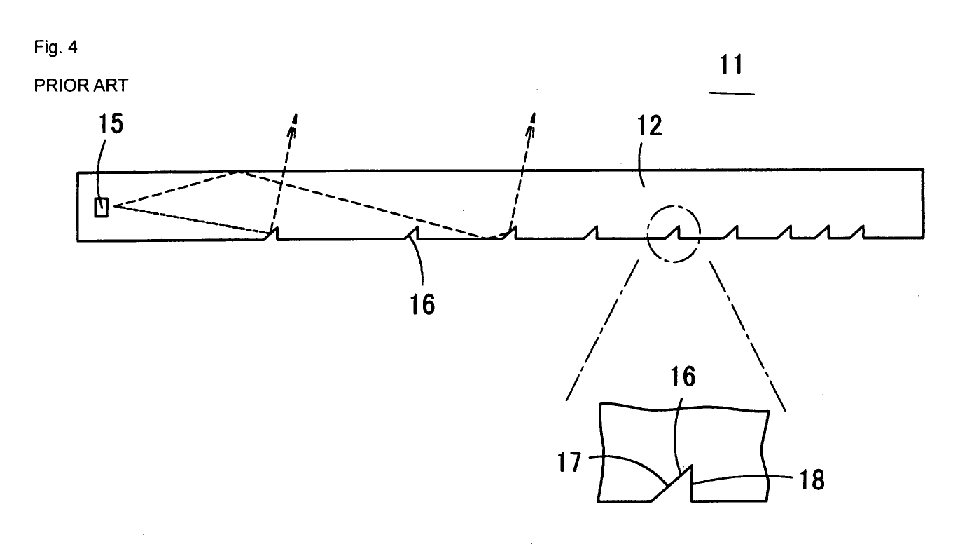

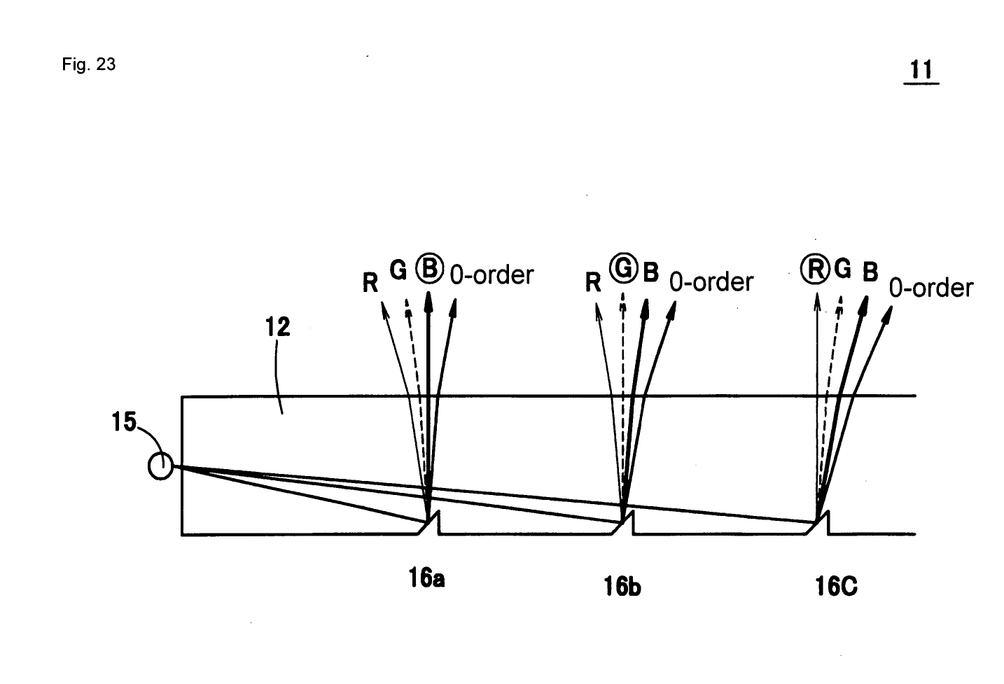

The coloring phenomenon in the prior art is studied based on the diffraction described above. In the surface light source device 11 shown in FIGS. 3, 4, the light incident to the deflection patterns 16 are substantially parallel to each other in the proximity of the spot light source 15. The light diffusion occurs, however, due to the Fraunhofer diffraction on the deflection slope 17 of the respective deflection patterns 16. In the conventional surface light source device 11, on the other hand, the deflection patterns 16 have a uniform shape (inclination angle γ of the deflection slope 17) and a uniform size (length a of the deflection slope 17). Nevertheless, as shown in FIG. 23, the incidence elevation angle α of the light incident to the deflection patterns 16 is varied with the distance from the spot light source 15. As a result, the direction in which the regular reflected light (zero-order diffracted light) is reflected is varied with the distance from the spot light source 15 on the one hand, and the diffraction angle θ varies according to Equation (5).

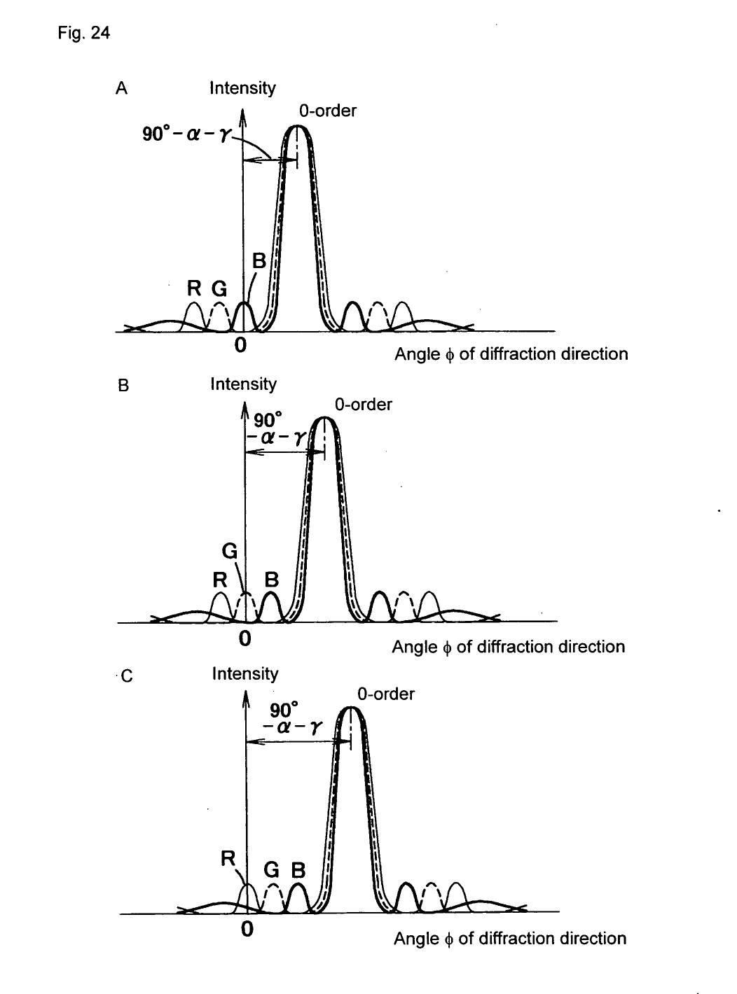

Consider, for example, as shown in FIG. 23, the pattern 16 near to the spot light source 15 (hereinafter referred to as the deflection pattern 16a), the deflection pattern 16 somewhat farther from the spot light source 15 (hereinafter referred to as the deflection pattern 16b) and the deflection pattern 16 far from the spot light source 15 (hereinafter referred to as the deflection pattern 16c). The incidence elevation angle α is largest for the deflection pattern 16a and smallest for the deflection pattern 16c. With regard to the light having the same wavelength, therefore, the diffraction angle θ is larger for the deflection pattern 16c than for the deflection pattern 16a. The diffraction patterns for the deflection patterns 16a, 16b, 16c are thus as shown in FIGS. 24A, B, C, respectively. In FIGS. 24A, B, C, the abscissa represents the angle φ of the diffraction direction as measured with reference to the direction N perpendicular to the light guide plate 12. As understood from FIG. 19, the angle φ of the diffraction direction and the diffraction angle θ have the relation shown below.
φ=θ+90°−(α+γ)
The direction of the regular reflected light (zero-order diffraction light), therefore, is displaced by 90°−(α+γ) from the direction φ=0°.

In the area of the deflection pattern 16a having the largest incidence elevation angle α, as shown in FIG. 24A, the displacement is smallest, and the regular reflected light exits obliquely while the diffracted light of blue (B) exits in the direction straight upward. In the area of the deflection pattern 16b having the middle incidence elevation angle α, as shown in FIG. 24B, the displacement is also middle, and the regular reflected light exits obliquely while the diffracted light of green (G) exits in the direction straight upward. Similarly, in the area of the deflection pattern 16c having the smallest incidence elevation angle α, as shown in FIG. 24C, the displacement is largest, and the regular reflected light exits obliquely while the diffracted light of red (R) exits in the direction straight upward. As a result, in the conventional surface light source device 11 as viewed from the vertical direction, as shown in FIG. 23, the portion of the deflection pattern 16a appears colored in blue, the portion of the deflection pattern 16b in green, and the portion of the deflection pattern 16c in red. In this way, different portions of the deflection patterns 16 appear in seven different colors. The diffracted light of R (read), G (green) and B (blue) emitted in vertical direction are designated by circles.

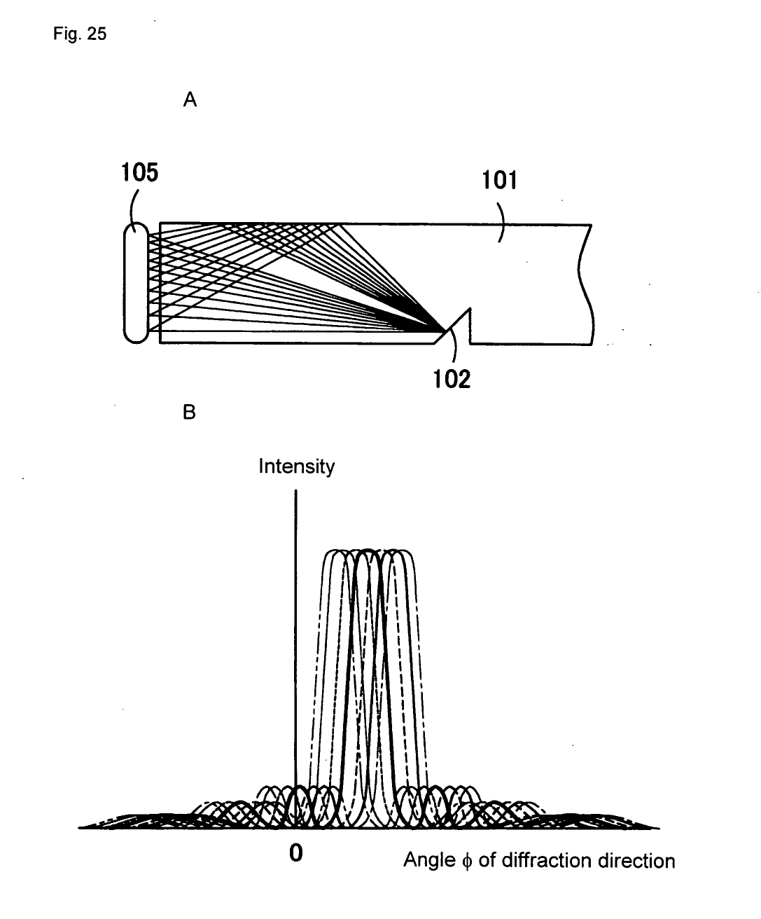

This coloring phenomenon is unique to a spot light source, and occurs only in the area near to the spot light source but not in the area far from the spot light source. In the case where the height of the light source 105 is not sufficiently small as compared with the thickness of the light guide plate 101 as shown in FIG. 25A and the light source 105 emits the light of uniform intensity, for example, the light enters the deflection pattern 102 from various angles. The diffraction characteristics of the light incident from various direction are varied slightly from one light to another as shown in FIG. 25B. As shown in FIG. 25B, therefore, even in the case where the light incident from various directions are separated into the spectral components by diffraction, the diffracted light having various wavelengths are mixed and whitened when viewed from the perpendicular direction, thereby eliminating the coloring phenomenon.

Although the light source shown in FIG. 25 has a larger height than the thickness of the light guide plate 101, no coloring phenomenon occurs also in the case of a light source not sufficiently short as compared with the width of the light guide plate like the cathode ray tube in which the light enters the deflection patterns from various directions.

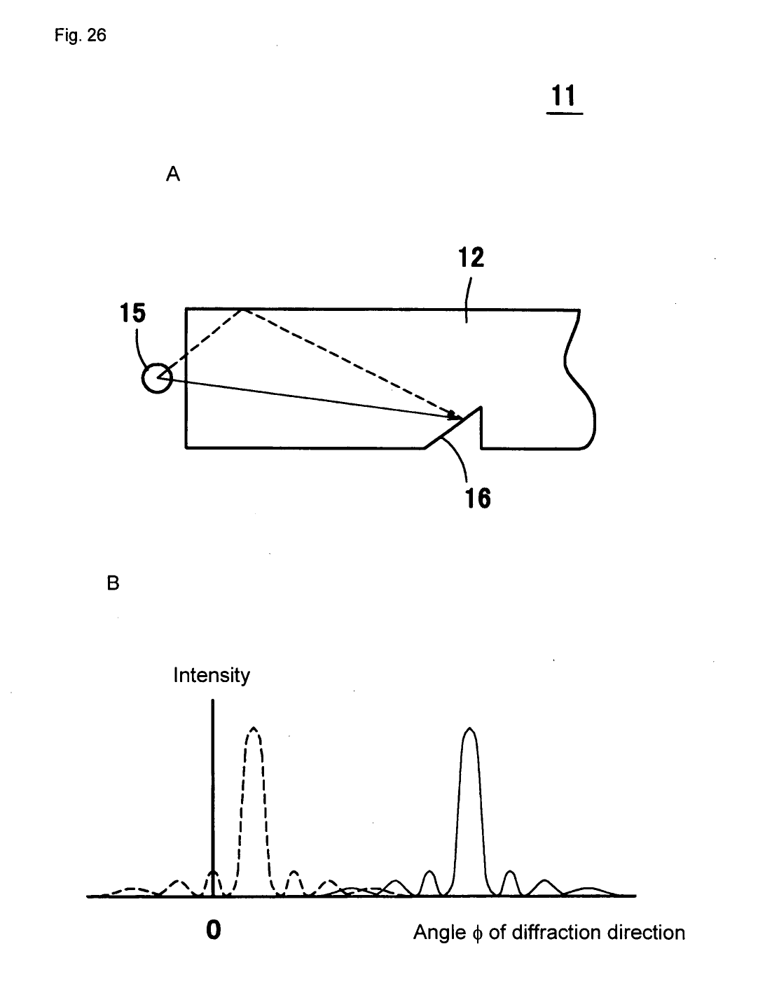

In the conventional surface light source device 11 using the spot light source 15, on the other hand, the light entering the deflection patterns 16 directly from the spot light source 15 and the light entering the deflection patterns 16 after being reflected on the light guide plate 12, as shown in FIG. 26A, are greatly varied from each other in the direction of incidence. Thus, the diffraction characteristics thereof are not superposed one on the other as shown in FIG. 26B, and the diffracted light having different wavelengths are not mixed with each other but emitted as they are from the light guide plate 12, thereby causing the coloring phenomenon in the proximity of the spot light source 15.

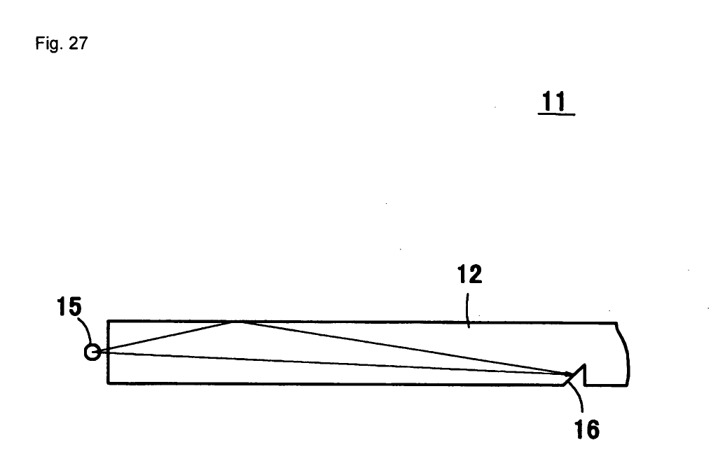

Even with the surface light source device 11 using the spot light source 15, however, the light entering the deflection patterns 16 directly from the spot light source 15 and the light entering the deflection patterns 16 after being reflected on the light guide plate 12, as shown in FIG. 27, have a smaller difference of the direction of incidence. As a result, the diffraction characteristics thereof are superposed one on the other and the diffracted light are mixed with each other, thereby eliminating the coloring phenomenon in the area far from the spot light source 15.

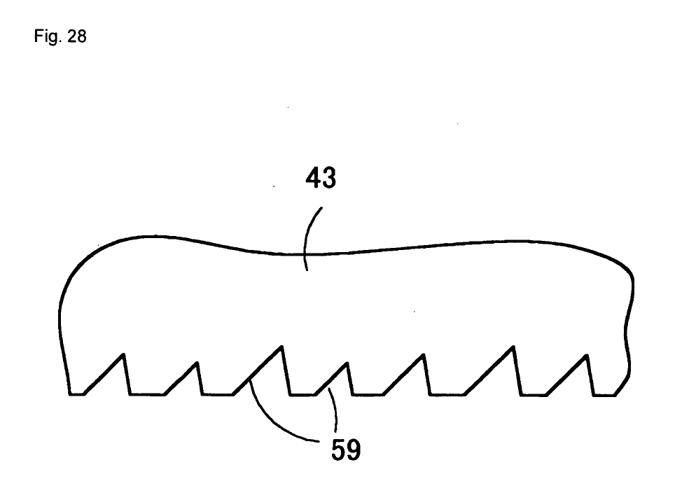

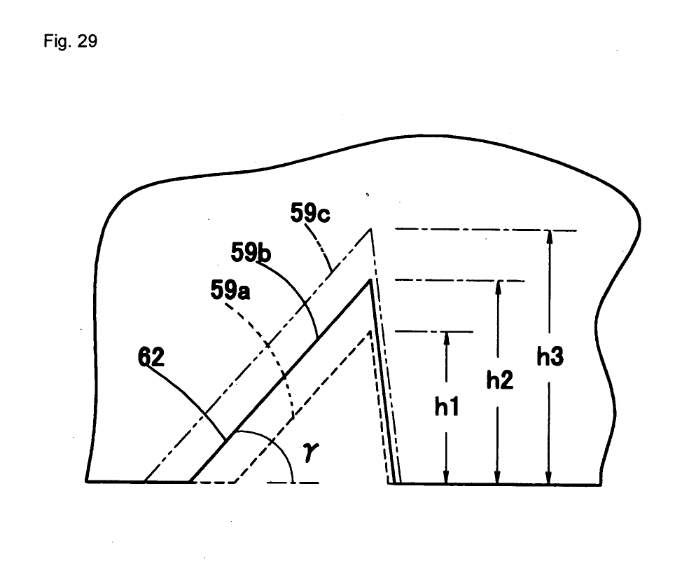

Next, the detail of the deflection patterns 59 in the surface light source device 41 according to this embodiment and the reason why the coloring phenomenon can be obviated by this device are explained. FIG. 28 is an enlarged view showing a part of the deflection pattern 59 formed on the reverse surface of the light guide plate 43. In this surface light source device 41, the deflection patterns 59 of different sizes are randomly or regularly arranged in an arbitrary minuscule area of the lower surface of the light guide plate 43. As an alternative, the size of the deflection pattern 59 is changed randomly or regularly within an arbitrary minuscule area. For example, a plurality of the deflection patterns 59 of different sizes similar in shape are mixed with each other. An explanation is made about a case in which, as shown in FIG. 29, the deflection patterns 59 are of three types including a smallest deflection pattern 59a, a middle deflection pattern 59b and a largest deflection pattern 59c among the deflection patterns 59. The three types of deflection patterns 59a, 59b, 59c have a substantially right angular cross section and are similar in shape to each other. The inclination angle γ of the deflection slope 62 is 55° for all of them. Also, the height of the deflection patterns 59a, 59b, 59c are h1=3.0 μm, h2=4.0 μm and h3=5.0 μm, respectively.

These deflection patterns 59a, 59b, 59c are arranged randomly in an arbitrary minuscule area on the lower surface of the light guide plate 43 in such a manner that the average height of the deflection patterns 59a, 59b, 59c is 4.0 μm in the particular minuscule area (such as in the case where the deflection patterns 59a, 59b, 59c having the height of h1, h2, h3 are equal in number, respectively). In designing the deflection patterns 59 of the light guide plate 43, therefore, the pattern density of the deflection patterns 59 is designed in accordance with the distance from the spot light source 42 on the assumption that the deflection patterns 59 of one type having the same height as the average height are distributed. After that, the size of the deflection patterns may be changed randomly in such a manner that the average height is equal to the design height. Nevertheless, the deflection slopes of the deflection patterns 59 at the same distance from the spot light source 42 are designed to have the same area. By designing this way, the optical design is conducted as in the prior art, and based on this design, the random deflection patterns 59 are designed.

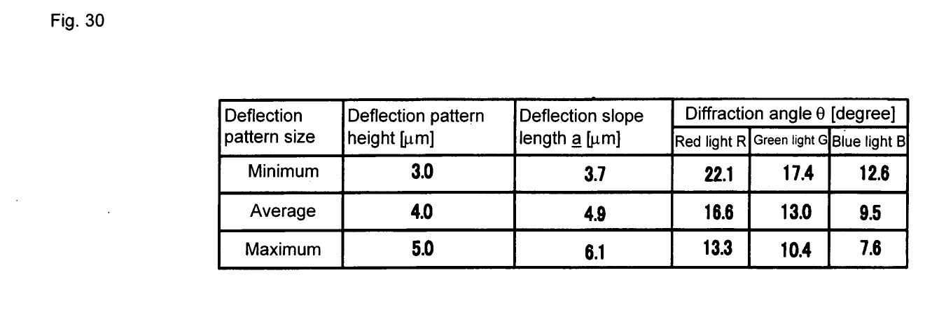

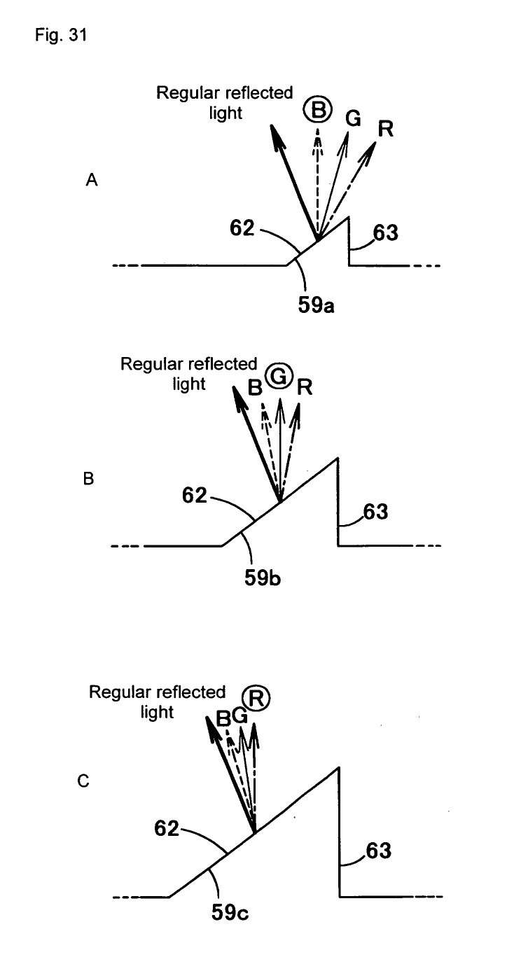

FIG. 30 shows the result of determining, by calculation according to Equation (5), the length a of h1/sin γ, h2/sin γ, h3/sin γ of the deflection slope 62 and the primary diffraction angle θ of the red light R, the green light G and the blue light B for the deflection pattern 59a having the height h1 of 3.0 μm and the inclination angle γ of 55° of the deflection slope 62, the deflection pattern 59b having the height h2 of 4.0 μm and the inclination angle γ of 55° of the deflection slope 62 and the deflection pattern 59c having the height h3 of 5.0 μm and the inclination angle γ of 55° of the deflection slope 62. In this calculation, the incidence elevation angle α is assumed to be 48°. The direction of the regular reflected light is 90°−α−γ=−13° with respect to the vertical direction N, and therefore, as understood from FIG. 30, the blue light (B) is emitted substantially perpendicularly for the deflection pattern 59a, the green light (G) is emitted substantially perpendicularly for the deflection pattern 59b, and the red light (R) is emitted substantially perpendicularly for the deflection pattern 59c. FIG. 31 shows this manner.

In the case where the minimum deflection pattern 59a, the middle deflection pattern 59b and the maximum deflection pattern 59c are arranged in a minuscule area (an area smaller than the resolution of the human eyes), the blue primary diffracted light due to the deflection pattern 59a, the green primary diffracted light due to the deflection pattern 59b and the red primary diffracted light due to the deflection pattern 59c are emitted in substantially the same direction (i.e. in substantially the vertical direction), and mixed with each other into white light. Specifically, according to this embodiment, only the size of the deflection patterns 59 is changed without changing the direction of the regular reflected light, and substantially the same direction of emission of the red, green and blue diffracted light can be secured by controlling the diffraction angle θ of the diffracted light. Thus, the white light is obtained, and the coloring phenomenon in the proximity of the spot light source 42 is prevented. Especially in the proximity of the light source 42, the coloring phenomenon can be sufficiently prevented by setting the minimum height of the deflection patterns at not more than 40% of the maximum height.

Also, even in the case where the direction in which the diffracted light of each color is displaced by about 1° due to the fabrication accuracy of the deflection patterns 59a, 59b, 59c of the light guide plate 43, the provision of a diffusion sheet on the surface of the light guide plate 43 expands by diffusion of the light by at least 2° even with a low haze and therefore can mix the diffracted light with each other.

This embodiment has been explained on the assumption that the deflection patterns 59 are of three types in size. By forming more types of deflection patterns 59, however, the light of different wavelengths can be mixed more easily and therefore the coloring phenomenon can be prevented more effectively.

### Second Embodiment

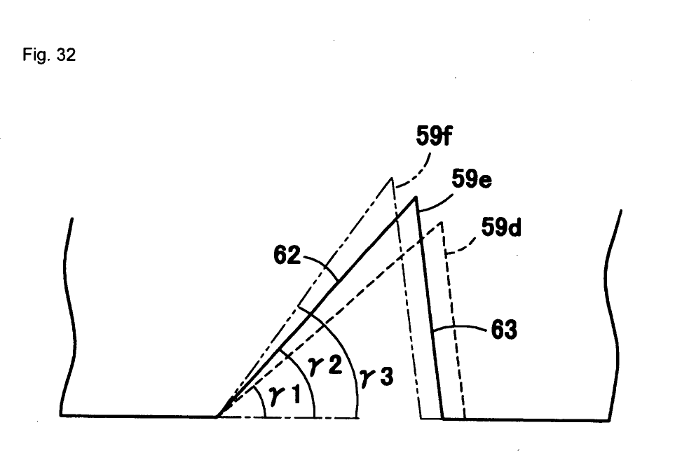

The second embodiment of the invention is substantially similar to the first embodiment except for the configuration of the deflection patterns 59 formed on the reverse surface of the light guide plate 43, and therefore explained mainly about the configuration of the deflection patterns 59. According to the second embodiment, a plurality of types of deflection patterns 59 having different inclination angles γ of the deflection slope 62 are arranged randomly or regularly on the reverse surface of the light guide plate 43, or the inclination angle γ of the deflection slope 62 of the deflection patterns 59 is randomly or regularly changed. FIG. 32 is an enlarged view showing a comparison of the cross sections of the plurality of types of deflection patterns 59 formed on the lower surface of the light guide plate 43. According to this embodiment, a plurality of types of the deflection patterns 59 having different inclination angles γ of the deflection slope 62 are arranged randomly in an arbitrary minuscule area on the lower surface of the light guide plate 43. For example, the inclination angle γ of the deflection slope 62 of the deflection patterns 59 is changed in the range of 45° to 55°, setting an angle γ of the average inclination angle is 50°

The description that follows deals with a case in which the deflection patterns 59 are of three types as shown in FIG. 32. The deflection patterns 59 having the smallest inclination angle γ are referred to as the deflection patterns 59d, those having the middle inclination angle γ as the deflection patterns 59e, and those having the largest inclination angle γ as the deflection patterns 59f. The three types of the deflection patterns 59d, 59e, 59f have substantially right triangular cross sections, and all have the same length a of the deflection slope 62 and the same inclination angle δ of the reentry surface 63. Also, the inclination angles γ1, γ2, γ3 of the deflection slopes 62 of the deflection patterns 59d, 59e, 59f are 47°, 50°, 53°, respectively. These deflection patterns 59d, 59e, 59f are arranged randomly in an arbitrary minuscule area on the lower surface of the light guide plate 43.

These deflection patterns 59d, 59e, 59f are arranged randomly in an arbitrary minuscule area on the lower surface of the light guide plate 43 as described above, and the average inclination angle of the deflection slopes 62 of the deflection patterns 59d, 59e, 59f in the minuscule gap is 50° (for, example, the deflection patterns in the same number have the same one of the inclination angles γ1, γ2, γ3). In designing the deflection patterns 59 of the light guide plate 43, therefore, the pattern density of the deflection patterns 59 is designed in accordance with the distance from the spot light source 42 on the assumption that the deflection patterns 59 of one type having the same inclination angle as the average inclination angle are distributed. After that, the inclination angle γ of the deflection patterns 59 may be changed randomly in such a manner that the average value of the inclination angles γ is equal to the design inclination angle. In this way, the optical design is conducted as in the prior art, and based on this design, the random deflection patterns 59 are designed.

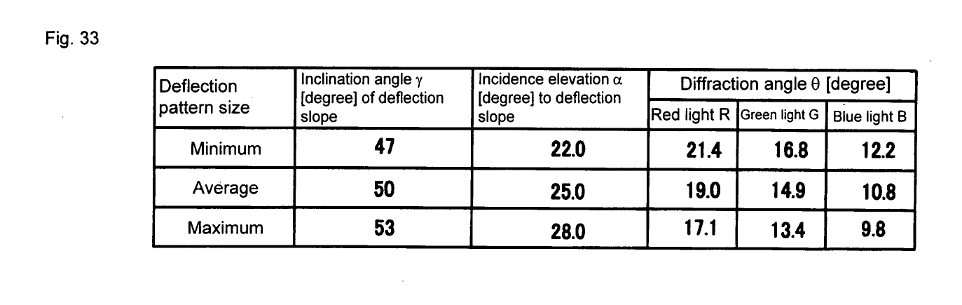

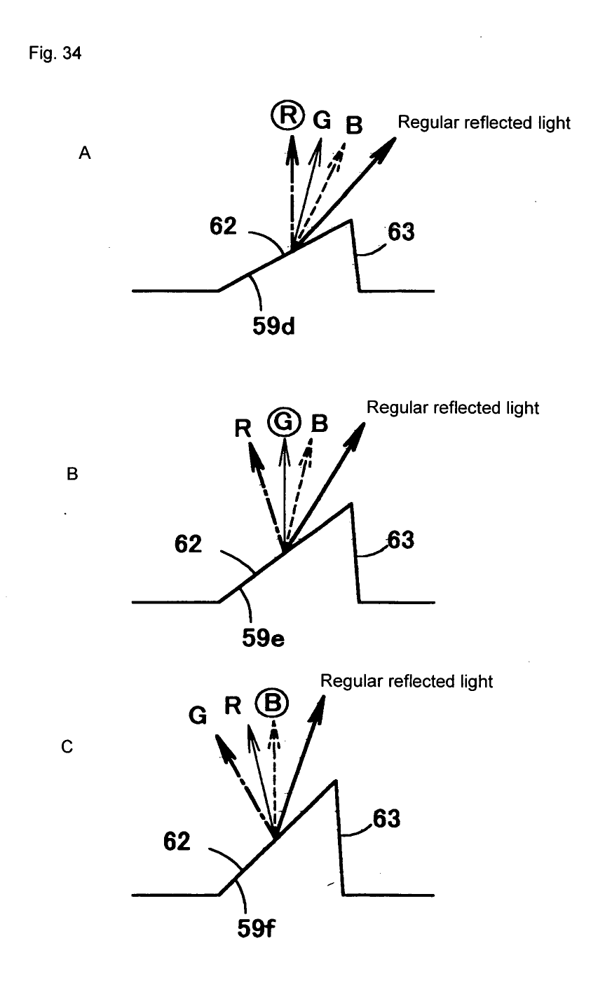

FIG. 33 shows the result of determining, by calculation according to Equation (5), the incidence elevation angle α to the deflection slope 62 and the primary diffraction angle θ of the red light R, the green light G and the blue light B for the deflection pattern 59d having the length a of 7.5 μm of the deflection slope 62 and the inclination angle γ of 47°, the deflection pattern 59e having the length a of 7.5 μm of the deflection slope 62 and the inclination angle γ of 50° and the deflection pattern 59f having the length a of 7.5 μm of the deflection slope 62 and the inclination angle γ of 53°. The direction of the regular reflected light for the deflection pattern 59d is 90°−α−γ=21° with respect to the vertical direction N, and therefore, as understood from FIG. 33, the red light (R) is emitted substantially vertically for the deflection pattern 59d. The direction of the regular reflected light for the deflection pattern 59d is 90°−α−γ=15° with respect to the vertical direction N, and therefore, as understood from FIG. 33, the green light (G) is emitted substantially vertically for the deflection pattern 59e. Similarly, the direction of the regular reflected light for the deflection pattern 59f is 90°−α−γ=9° with respect to the vertical direction N, and therefore, as understood from FIG. 33, the blue light (B) is emitted substantially vertically for the deflection pattern 59f. FIG. 34 shows this manner.

In the case where the deflection pattern 59d having the minimum inclination angle, the deflection pattern 59e having the middle inclination angle and the deflection pattern 59f having the maximum inclination angle of the deflection slope 62 are arranged in the minuscule area, the red primary diffracted light due to the deflection pattern 59d, the green primary diffracted light due to the deflection pattern 59e and the blue primary diffracted light due to the deflection pattern 59f are emitted in substantially the same direction (i.e. substantially vertically), and mixed into white light. Specifically, according to this embodiment, only the inclination angle γ of the deflection patterns 59 is changed without substantially changing the direction of reflection of the regular reflected light. Thus, by controlling the diffraction angle θ of the diffracted light, the directions of emission of the red, green and blue diffracted light are rendered substantially coincident to produce white light, thereby preventing the coloring phenomenon in the proximity of the spot light source 42.

The explanation made above refers to a case in which the three types of deflection patterns 59 having the inclination angles γ of 47°, 50°, 53° of the deflection slope 62. By changing the inclination angle γ randomly in multiple steps with the inclination angle γ in the range of 50°±5°, however, the light of different wavelengths are more easily mixed and therefore the coloring phenomenon can be prevented more effectively.

Also, even in the case where the direction in which the diffracted light of each color is emitted is displaced by about 1° due to the fabrication accuracy of the deflection patterns 59d, 59e, 59f of the light guide plate 43, the provision of a diffusion sheet on the surface of the light guide plate 43 diffuses and spreads the light by at least 2° even with a low haze, and therefore the diffracted light can be mixed with each other.

According to this embodiment, the inclination angle γ of the deflection slope 62 is changed while maintaining a constant length of the deflection slope 62, to which case the invention is not limited. For example, the inclination angle γ of the deflection slope 62 may be changed while maintaining a predetermined height of the deflection patterns 59.

### Modifications of First and Second Embodiments

In the first and second embodiments, the size of the deflection patterns 59 or the inclination angle γ of the deflection slope 62 is changed over the whole surface light-emitting area 45 of the light guide plate 43. As explained with reference to the first embodiment, however, the coloring phenomenon occurs in the proximity of the spot light source 42 of the surface light-emitting area 45. Therefore, the size of the deflection patterns 59 or the inclination angle γ of the deflection slope 62 is not necessarily changed over the whole surface light-emitting area 45, but sufficiently only in the proximity of the spot light source 42.

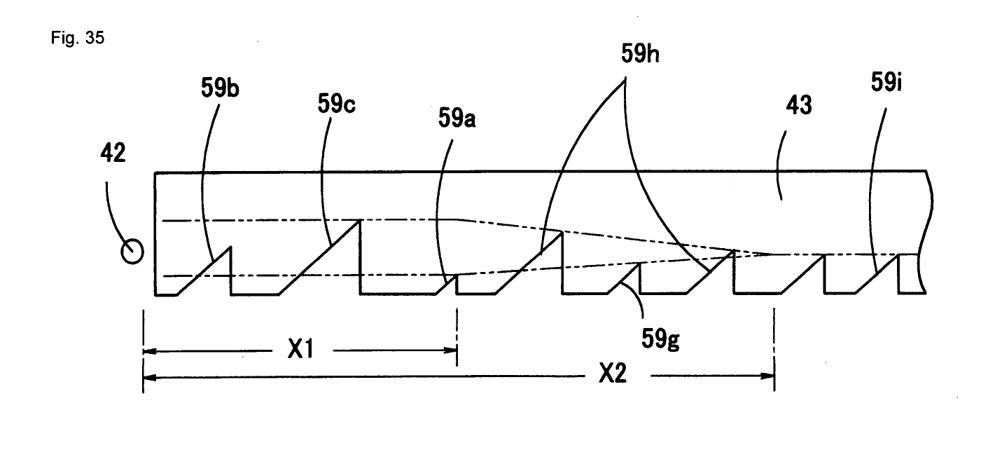

FIG. 35 is a sectional view schematically showing a modification in which the diffraction characteristic due to the deflection patterns 59 is changed only in the proximity of the spot light source 42 of the light guide plate 43. In the light guide plate 43 shown in FIG. 35, the deflection patterns 59a, 59b, 59c of different sizes are arranged randomly in the area of up to X1 in distance from the spot light source 42. In this area, the coloring phenomenon can be effectively prevented by decreasing the minimum height of the deflection patterns to 40% or less of the maximum height thereof. In the area where the distance from the spot light source 15 is not less than X2, on the other hand, only the deflection patterns 59i having the average size are arranged. The distances X1, X2 are determined taking the range of the area where the coloring phenomenon develops in the conventional surface light source device into consideration.

In the area where the distance from the spot light source 15 is not less than X1 but not more than X2, the deflection patterns 59g, 59h of different sizes are arranged in such a manner that the size of the deflection patterns 59g, 59h is varied to a lesser degree progressively with the increase in the distance from the spot light source 42. Specifically, in this area, the difference in size between the largest deflection pattern 59h and the smallest deflection pattern 59g at a particular point is progressively decreased with the increase in the distance from the spot light source 42. The degree of size variation between the deflection patterns 59g, 59h at an end near to the spot light source 42 in the area between X1 and X2 inclusive is equal to the size variation between the deflection patterns 59a, 59b, 59c in the area of X1 or less, while the size of the deflection patterns 59g, 59h is not varied at all at the end far from the spot light source 42.

For example, the deflection patterns 59a having the height of 3 μm, the deflection patterns 59b having the height of 4 μm and the deflection patterns 59c having the height of 5 μm are randomly arranged in the area where the distance from the spot light source 42 is smaller than X1 of 8 mm. In the area where the distance from the spot light source 42 is larger than X2 of 16 mm, only the deflection patterns 59i having the height of 4 μm are arranged. Also, in the area where the distance from the spot light source 42 is larger than X1 of 8 mm and smaller than X2 of 16 mm, the height of the highest deflection patterns 59h is progressively decreased from 5 μm to 4 μm with the increase in the distance from the spot light source 42 on the one hand, and the height of the lowest deflection pattern 59g is progressively increased from 3 μm to 4 μm with the increase in the distance from the spot light source 42 on the other hand. In all of these areas, the average height of the deflection patterns 59 is 4 μm. Although the height of both the deflection patterns 59g, 59h are changed in this case, the deflection patterns 59h may be kept at a constant height while the height of the deflection patterns 59g may be progressively increased, or the deflection patterns 59g may be kept at a constant height while the height of the deflection patterns 59h may be progressively decreased.

In this way, as long as an area having the deflection patterns 59g, 59h of different sizes with the degree of randomness thereof progressively decreased is interposed between an area formed with the deflection patterns 59a, 59b, 59c of different sizes randomly and an area formed with the deflection patterns 59i having a uniform size, the boundary between the area having a large degree of randomness in the size of the deflection patterns and the area having the deflection patterns of a uniform size becomes less conspicuous, and the development of a salient boundary line is prevented.

Although a case is explained above in which the height of the deflection patterns 59 is changed randomly, the inclination angle γ of the deflection slope 62 of the deflection patterns 59 may be changed randomly as an alternative.

### Third Embodiment

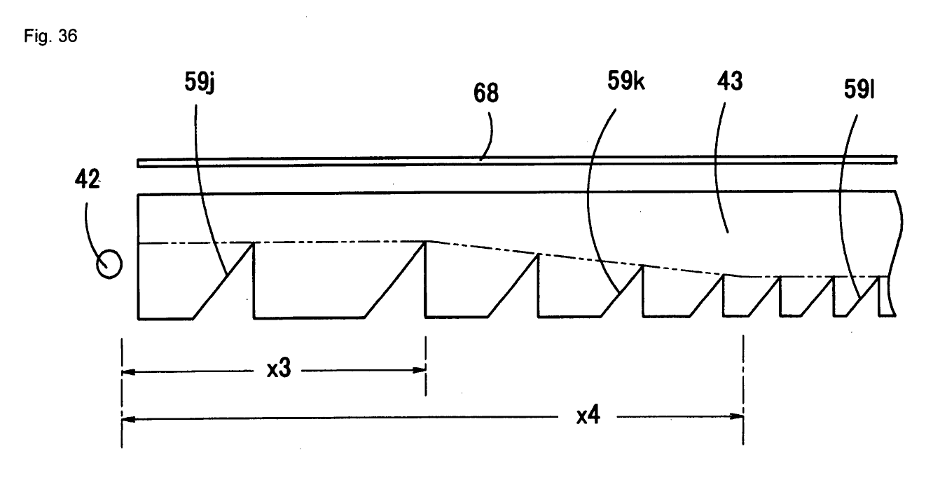

FIG. 36 is a partly cutaway sectional view schematically showing the surface light source device according to a third embodiment of the invention. In this embodiment, the deflection patterns of different height are arranged in the area where the distance from the spot light source 42 is not more than X3, the area where the distance is between X3 and X4 inclusive and the area where the distance is more than X4.

In the area having the distance of not more than X3 from the spot light source 42, the high deflection patterns 59j are formed. In the area having the distance of not less than X4 from the spot light source 42, the low deflection patterns 591 are formed. The height of the low deflection patterns 591 is substantially equal to the average height of the deflection patterns 59 formed over the whole light guide plate in the prior art. The height of the high deflection patterns 59j, for example, is about two to five times as large as that of the low deflection patterns 591. In the area having the high deflection patterns 59j, the pattern density is correspondingly lower than in the area having the low deflection patterns 591 to secure a uniform brightness.

Also, in the area having the distance of between X3 and X4 inclusive from the spot light source 42, the deflection patterns 59k are formed. With the increase in the distance from the spot light source 42, the deflection patterns 59k are progressively changed from a height equal to the height of the high deflection patterns 59j to a height equal to the height of the low deflection patterns 591. In this way, the area in which the height of the deflection patterns 59k is progressively changed is interposed between the area formed with the high deflection patterns 59j and the area formed with the low deflection patterns 591. Therefore, the height of the deflection patterns is not changed abruptly and the boundary line becomes less conspicuous.

For example, the deflection patterns 591 are set to the same 4 μm as in the prior art in the area where the distance from the spot light source 42 is not less than X4 of 16 mm. Also, the height of the deflection patterns 59j formed in the area where the distance from the spot light source 42 is not more than X3 is set to 20 μm or five times as large as in the prior art. The interval (period) between the high deflection patterns 59j is set to about five times as large as the interval between the low deflection patterns 591 to secure a uniform brightness of the light guide plate 43. In the area where the distance from the spot light source 42 is between X3 and X4 inclusive, on the other hand, the height of the deflection patterns 59k changes progressively from 20 μm to 4 μm and the interval thereof is proportional to the ratio of the height of the deflection patterns 59k.

The provision of the deflection patterns 59j having the height of 20 μm in the proximity of the spot light source 42 results in the diffraction angle θ of the primary diffracted light in the same area as:

5.0° for red light R

3.9° for green light G, and

2.8° for blue light B (FIG. 30)

Thus, the difference in diffraction angle between the red primary diffracted light and the blue primary diffraction angle becomes about 2°. Although the expansion of about 5° of the diffraction angle as in the prior art makes it difficult to whiten the color even by use of the diffusion sheet, the expansion of about 2° of the diffraction angle diffuses and expands the light at least about 2° using a diffusion sheet even with a low haze, and the primary diffracted light can be mixed with each other by placing the diffusion sheet 68 on the light guide plate 43. Thus, the primary diffracted light emitted from the surface light source device can be whitened.

Instead of changing the height of the deflection patterns 59 as in this embodiment, the inclination angle γ of the deflection slope 62 of the deflection patterns 59 may be changed with equal effect.

### Fourth Embodiment

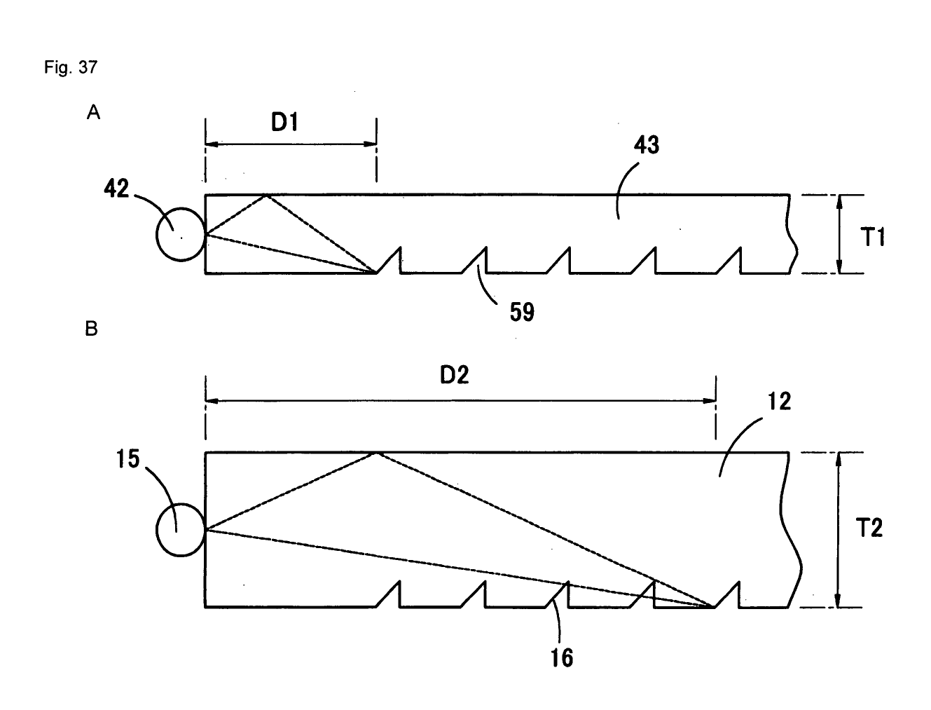

FIG. 37A is a partly cutaway sectional view schematically showing the surface light source device 41 according to a fourth embodiment of the invention. This embodiment is characterized in that the thickness of the light guide plate 43 is as small as “one several-th” of the conventional light guide plate. Specifically, the thickness T1 of the light guide plate 43 is between 0.1 mm and 0.4 mm inclusive. The thickness T1 of less than 0.1 mm of the light guide plate 43 reduces the efficiency of introducing the exit light from the spot light source 42 from the end surface of the light guide plate 43, while the thickness T1 of more than 0.4 mm of the light guide plate 43 is liable to cause the coloring phenomenon in the proximity of the spot light source 42. This is the reason why the thickness T1 of the light guide plate is set to not less than 0.1 mm but not more than 0.4 mm.

The desirable thickness T1 of the light guide plate 43 is about 0.2 mm. The thickness T1 of 0.2 mm of the light guide plate 43 leads to the interval of 2.9° of the incidence angle of the light to the deflection patterns 59 located at D1 of 4 mm from the spot light source 42. In the conventional surface light source device having the thickness T2 of 0.85 mm of the light guide plate 12, on the other hand, as shown in FIG. 37B, the interval of the incidence angle to the deflection patterns 16 located at position D2 of 17 mm from the spot light source 15 is 2.9°. Experiments confirm that this incidence angle interval causes no coloring phenomenon. By reducing the thickness of the light guide plate 43 to “one several-th”, therefore, the coloring phenomenon even in the proximity of the spot light source 42 can be suppressed.

(Liquid Crystal Display Device)

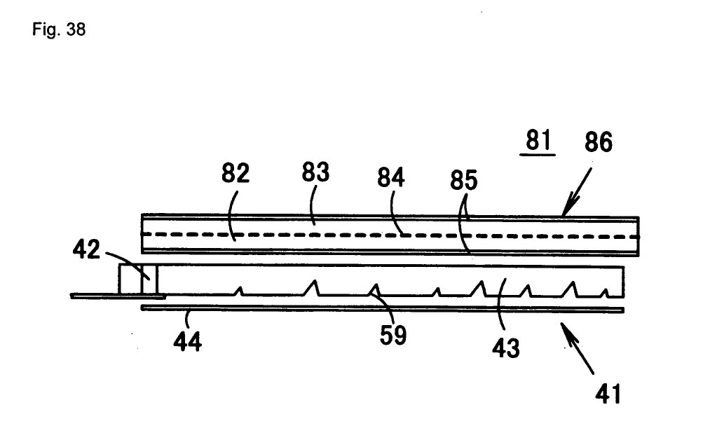

FIG. 38 is a sectional view schematically showing a liquid crystal display device 81 according to this invention. In this liquid crystal display device 81, the surface light source device 41 according to the invention is arranged on the back of the liquid crystal display panel 86. The liquid crystal display panel 86 includes a liquid crystal layer 84 held and sealed between a back substrate 82 formed with a switching element such as TFT (thin-film transistor) and a front substrate 83 formed with a transparent electrode and a color filter. A polarization plate 85 is laid on each of the front and back surfaces. In this liquid crystal display device 81, the liquid crystal display panel 86 is lighted from the back side by turning on the surface light source device 41, and each pixel of the liquid crystal display panel 86 is turned on/off thereby to generate an image.

The surface light source device according to the invention is applicable also to the front light, and therefore, can be used with a reflection-type liquid crystal display device, though not shown.

(Applications)

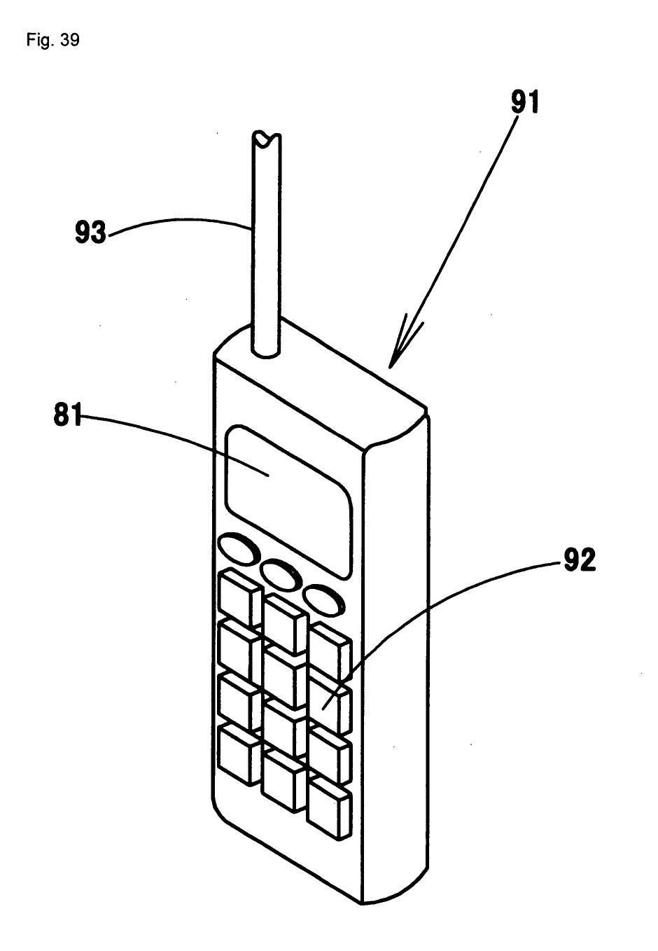

FIG. 39 shows a mobile phone 91 having built therein the liquid crystal display device 81 according to the invention. In this mobile phone 91, the liquid crystal display device 81 is built in as a display on a dial portion 92 having ten-keys and has an antenna 93 on the upper surface thereof.

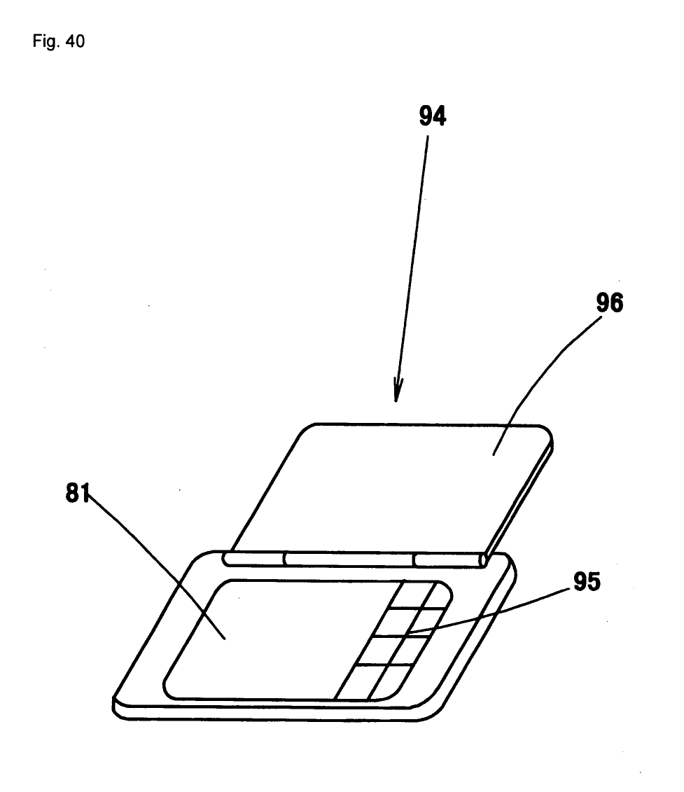

FIG. 40 shows a portable information terminal 94 such as PDA having built therein the liquid crystal display device 81 according to the invention as a display. In this portable information terminal 94, an input unit 95 for inputting data by pen is arranged beside the liquid crystal display device 81, and has a cover 96 pivotally supported at the upper end portion thereof.

The use of the liquid crystal display device 81 according to the invention for the mobile phone 91 or the portable information terminal 94 makes it difficult to develop the coloring phenomenon on the screen and can realize a display unit having a high visibility.

According to this invention, the coloring phenomenon on the light exit surface of the surface light source device using a light source or especially, the coloring phenomenon in the proximity of a spot light source of the surface light source device can be prevented.

What is claimed is:

1. A surface light source device comprising:
a light guide plate for containing and expanding the light in planar form, and for emitting the light from a light exiting surface; and
a light source for causing the light to enter the light guide plate;
wherein a plurality of convex or concave deflection patterns are formed on the other surface of the light guide plate opposite to the light exiting surface,
wherein a plurality of types of deflection patterns of different diffraction characteristics are arranged in at least a part of the deflection pattern forming area, and
wherein the light emitting from the light guide plate is whitened by mixing the light diffracted by the deflection patterns.

2. A surface light source device comprising:
a light guide plate for containing and expanding the light in planar form, and for emitting the light from a light exiting surface; and
a light source for causing the light to enter the light guide plate;
wherein a plurality of convex or concave deflection patterns are formed on the other surface of the light guide plate opposite to the light exiting surface, and
wherein a plurality of types of deflection patterns having different cross sections are arranged in at least a part of the deflection pattern forming area.

3. A surface light source device according to claim 2,
wherein the shape of the cross section of the deflection patterns is changed by changing the height of the deflection patterns.

4. A surface light source device according to claim 3,
wherein the minimum height of the deflection patterns is not more than 40% of the maximum height thereof.

5. A surface light source device according to claim 2,
wherein the deflection patterns have a substantially triangular cross section, and the shape of the cross section is changed by changing the inclination angle of the light incidence surface of the deflection patterns.

6. A surface light source device according to claim 2,
wherein the average shape of the cross section of the deflection patterns is substantially uniform over the whole deflection pattern forming area.

7. A surface light source device according to claim 2,
wherein the deflection slopes of the deflection patterns formed at points having the same distance from the light source have the same area.

8. A surface light source device according to claim 2,
wherein a plurality of types of the deflection patterns having different shapes of cross section are arranged in the proximity of the light source,
wherein the deflection patterns having a uniform shape of cross section are arranged in an area far from the light source, and
wherein a plurality of types of the deflection patterns having different shapes of cross section are arranged between the area in the proximity of the light source and the area far from the light source in such a manner that the difference of the shape of cross section between the different types of the deflection patterns is progressively reduced from the area in the proximity of the light source toward the area far from the light source.

9. A surface light source device comprising:
a light guide plate for containing and expanding the light in planar form, and for emitting the light from a light exiting surface; and
a light source for causing the light to enter the light guide plate;
wherein a plurality of convex or concave light deflection patterns are formed on the other surface of the light guide plate opposite to the light exiting surface,
wherein the deflection patterns having a uniform shape of the cross section are formed in the area far from the light source, and
wherein the deflection patterns having a uniform cross section larger than the deflection patterns formed in the area far from the light source are formed in the area in the proximity of the light source.

10. A surface light source device comprising:
a light guide plate for containing and expanding the light in planar form, and for emitting the light from a light exiting surface; and
a light source for causing the light to enter the light guide plate;
wherein a plurality of convex or concave light deflection patterns are formed on the other surface of the light guide plate opposite to the light exiting surface, and
wherein the thickness of the light guide plate is not more than 0.4 mm.

11. An image display device comprising:
a surface light source device; and
an image display panel;
the surface light source comprising:
a light guide plate for containing and expanding the light in planar form, and for emitting the light from a light exiting surface; and
a light source for causing the light to enter the light guide plate;
wherein convex or concave light deflection patterns are formed on the other surface of the light guide plate opposite to the light exiting surface, and
wherein a plurality of different types of deflection patterns having different shapes of cross section are arranged in at least a part of the deflection pattern forming area.

12. A portable device comprising:
information input means; and
an image display unit for displaying the information input by the information input means;
the image display device comprising:
a surface light source device; and
an image display panel;
the surface light source device comprising:
a light guide plate for containing and expanding the light in planar form, and for emitting the light from a light exiting surface; and
a light source for causing the light to enter the light guide plate;
wherein a plurality of convex or concave deflection patterns are formed on the other surface of the light guide plate opposite to the light exiting surface, and
wherein a plurality of types of deflection patterns having different shapes of cross section are formed in at least a part of the deflection pattern forming area.
